(19) United States
(12) Patent Application Publication
(10) Pub. No.: US 2010/0281498 A1
(43) Pub. Date: Nov. 4, 2010

(54) INFORMATION PROVIDING DEVICE, INFORMATION DISPLAY DEVICE, INFORMATION PROVIDING SYSTEM, CONTROL METHOD, CONTROL PROGRAM AND STORAGE MEDIUM

(76) Inventors: Yoshitaka Tanemura, Osaka (JP); Masaki Hashiura, Osaka (JP); Kentaro Sakakura, Osaka (JP); Masayuki Shimada, Osaka (JP); Kiyotaka Kashito, Osaka (JP)

Correspondence Address: BIRCH STEWART KOLASCH & BIRCH, PO BOX 747, FALLS CHURCH, VA, 22040-0747, US

(21) Appl. No.: 12/810,419

(22) PCT Filed: Dec. 22, 2008
(86) PCT No.: PCT/JP2008/073910

§ 371 Date: Jun. 24, 2010

Related U.S. Application Data
(60) Provisional application No. 61/009,209, filed on Dec. 27, 2007.

(30) Foreign Application Priority Data
May 16, 2008 (JP) 2008-130033
May 16, 2008 (JP) 2008-130035

(51) Int. Cl. H04N 5/445; H04N 7/16

(52) U.S. Cl. 725/25; 725/38

(57) ABSTRACT

A digital television (1) of the present invention includes a relevant information storage section (170) which stores relevant information concerning the digital television (1), and a display data request processing section (32) which transmits, to a sidebar providing server (2), a display data request message for requesting display data. The display data request processing section (32) transmits, to the sidebar providing server (2), relevant information specified by a control script among relevant information stored in the relevant information storage section (170), the relevant information being transmitted in accordance with the control script for requesting the relevant information, the control script being transmitted from the sidebar providing server (2) in response to the display data request message. With this arrangement, it is possible to efficiently utilize information necessary for customization of contents. This allows an improvement in processing efficiency of the information display device.

### TECHNICAL FIELD

The present invention relates to an information providing device, an information display device, an information providing system, a control method, a control program and a storage medium, each of which is for providing information to a user of the information display device via a communication network.

### BACKGROUND ART

In recent years, various functions are provided to not only a general-purpose device (e.g. computer) but also an application specific device (e.g. a television, a portable phone and a game machine) in addition to its original function, and the application specific device has been used as a multifunction device. In recent years, these devices include, as standard equipment, a communication function for communicating with an external device via an external communication network (e.g. the Internet). The devices can receive, via internet, various services from a service distributing server for distributing various services. For example, a television or a portable phone can receive weather forecast information form a service provider which provides the weather forecast information, and to display the weather forecast information on its display section. That is, a user can use the devices as an information display device which acquires information from a service provider and displays the information.

A wide variety of devices having different use, shape and function are used as the information display device by a wide variety of users. In such a circumstance, it is desirable that the service provider can provide contents customized for individual information display device in consideration of variety of the information display device.

For example, Patent Document 1 discloses an image display system in which an information display device (e.g. television) transmits a message for requesting display data (contents) and information of the information display device to a server (service provider), and the server provides the information display device with the display data customized based on the information of the information display device.

[Patent Document 1]

Japanese Unexamined Patent Application Publication Tokukai No. 2008-035503 (published on Feb. 14, 2008), Japanese Patent Application No. 2007-168098 (filed on Jun. 26, 2007)

[Patent Document 2]

Japanese Unexamined Patent Application Publication Tokukai No. 2007-114402 (published on May 10, 2007)

### DISCLOSURE OF INVENTION

### Problems to be Solved by the Invention

In the system disclosed in the Patent Document 1, when the information display device requests the display data, the information display device acting as a client should transmit information necessary for the customization to an information providing device acting as a server.

In this case, it is desirable that the information necessary for the customization is registered, stored, and transmitted to the information providing device in the easiest way so that the information display device can efficiently acquire the customized display data from the information providing device.

The present invention was attained in view of the above circumstance. An object of the present invention is to provide an information providing device, an information display device, an information providing system, a control method, a control program and a storage medium, each of which improves processing efficiency of the information display device by realizing efficient utilization of information necessary for customization of contents.

### Means to Solve the Problems

In order to attain the object, an information display device of the present invention is an information display device for (i) processing display data for displaying information, the display data being provided by an information providing device and (ii) displaying the information, comprising: a relevant information storage section for storing relevant information concerning the information display device; a request processing section for transmitting a display data request message to the information providing device, the display data request message requesting the information providing device to provide the display data; and a relevant information transmitting section for transmitting, to the information providing device, relevant information specified by a control script among the relevant information stored in the relevant information storage section, the relevant information being transmitted in accordance with the control script for requesting the relevant information, the control script being transmitted from the information providing device in response to the display data request message.

According to the above arrangement, the information display device transmits the display data request message for requesting the display data, the display data request message not including the relevant information. In response to the request for the relevant information from the information providing device, the information display device transmits the requested relevant information to the information providing device.

This allows the information display device to transmit, to the information providing device, only necessary relevant information only when requested by the information providing device.

This improves efficiency of processing of acquiring/displaying display data in the information display device.

In order to attain the object, an information providing device of the present invention includes: a relevant information specification section for specifying relevant information concerning an information display device, the relevant information being necessary for generating the display data for displaying the information on the information display device, the display data being generated in response to the display data request message for requesting the display data, the display data request message being transmitted from the information display device; a control script generation section for generating the control script for requesting the information display device to provide the relevant information specified by the relevant information specification section; and a display data generation section for generating the display data to be provided to the information display device in a manner such that the display data is customized based on the relevant information transmitted from the information display device in response to an instruction of the control script to provide the relevant information.

According to the above arrangement, in response to the request for the display data from the information display device, the information providing device specifies necessary relevant information, and requests the information display device to provide the relevant information. The information providing device generates display data for the information display device on the basis of the relevant information transmitted from the information display device.

This allows the information display device to transmit, to the information providing device, only necessary relevant information only when requested by the information providing device.

This improves efficiency of processing of acquiring/displaying display data in the information display device.

In order to attain the object, an information providing system of the present invention includes the information display device and the information providing device.

According to the above arrangement, the information display device transmits the display data request message for requesting the display data, the display data request message not including the relevant information. In response to the request for the relevant information from the information providing device, the information display device transmits the requested relevant information to the information providing device. The information providing device generates the display data for the information display device on the basis of the relevant information transmitted from the information display device.

This allows the information display device to transmit, to the information providing device, only necessary relevant information only when requested by the information providing device.

This improves efficiency of processing of acquiring/displaying display data in the information display device.

In order to attain the object, a method for controlling an information display device of the present invention is a method for controlling an information display device which displays information by processing display data for displaying the information, which display data is provided by an information providing device, the method comprising the steps of: transmitting a display data request message for requesting the information providing device to provide display data; and transmitting, to the information providing device, relevant information specified by a control script among relevant information stored in relevant information storage section which stores relevant information concerning the information display device, the relevant information being transmitted in accordance with the control script for requesting the relevant information, the control script being transmitted from the information providing device in response to the display data request message.

In order to attain the object, a method for controlling an information providing device of the present invention includes the steps of: specifying relevant information concerning an information display device, the relevant information being necessary for generating display data for displaying information on the information display device, the display data being generated in response to a display data request message for requesting the display data, the display data request message being transmitted from the information display device; generating a control script for requesting the information display device to provide the specified relevant information; and generating the display data to be provided to the information display device in a manner such that the display data is customized based on the relevant information transmitted from the information display device in response to an instruction of the control script to provide the relevant information.

### EFFECTS OF THE INVENTION

The above arrangement and method make it possible to increase processing efficiency of the information display device by efficiently utilizing information necessary for customization of contents.

### BRIEF DESCRIPTION OF DRAWINGS

FIG. 1 is a schematic view showing a configuration of a service providing system of an embodiment of the present invention.

FIG. 2 is a schematic view showing an example of a configuration of a digital television of the embodiment of the present invention.

FIG. 3 is a view schematically illustrating a data structure of a display data request message that is generated by a display data request processing section of the digital television.

FIG. 4 is a block diagram schematically illustrating an arrangement of a sidebar providing server in the embodiment of the present invention.

FIG. 5 is a view schematically showing a data structure of display data generated by a display data generation section of the sidebar providing server.

FIG. 6 is a sequence diagram showing a processing flow of each device in the service providing system of the embodiment of the present invention.

FIG. 7 (a) is a view showing a concrete example of a display screen of the digital television on which a sidebar is displayed.

FIG. 7 (b) is a view showing a concrete example of a display screen of the digital television on which a sidebar is displayed.

FIG. 8 is a view showing a concrete example of a display screen of the digital television on which a service is displayed.

FIG. 9 is a block diagram schematically illustrating an arrangement of the digital television in the embodiment of the present invention.

FIG. 10 (a) is a view showing a concrete example of registration information stored in a relevant information storage section.

FIG. 10 (b) is a view showing a concrete example of fixed information stored in the relevant information storage section.

FIG. 10 (c) is a view showing a concrete example of state information stored in the relevant information storage section.

FIG. 11 is a view showing a concrete example of a display screen of the digital television on which a menu screen is displayed.

FIG. 12 is a view showing a concrete example of a display screen of the digital television on which a prompt screen for prompting a user to input a postal code (Zip code) is displayed.

FIG. 13A is a view explaining an operation of a pattern data selecting section for selecting pattern data by using data stored in a pattern data storage section of the sidebar providing server.

FIG. 13B is a view showing a concrete example of various kinds of data stored in the pattern data storage section.

FIG. 14 (a) is a view concretely showing a part of the pattern data A among three pattern data (SVG data of a fixed form, patterns A through C) shown in FIG. 13B.

FIG. 14 (b) is a view concretely showing a part of the pattern data B among three pattern data (SVG data of a fixed form, patterns A through C) shown in FIG. 13B.

FIG. 14 (c) is a view concretely showing a part of the pattern data C among three pattern data (SVG data of a fixed form, patterns A through C) shown in FIG. 13B.

FIG. 15 (a) is a view concretely showing a shape and size of a sidebar and the number of services in a case in which the sidebar is displayed on the display section.

FIG. 15 (b) is a view concretely showing a shape and size of a sidebar and the number of services in a case in which the sidebar is displayed on the display section.

FIG. 15 (c) is a view concretely showing a shape and size of a sidebar and the number of services in a case in which the sidebar is displayed on the display section.

FIG. 16 (a) is a view showing a concrete example of a fixed form of the SVG data.

FIG. 16 (b) is a view showing a concrete example of a fixed form of the SVG data.

FIG. 16 (c) is a view showing a concrete example of a fixed form of the SVG data.

FIG. 17 is a block diagram schematically illustrating an arrangement of the digital television in another embodiment of the present invention.

FIG. 18 is a view showing a concrete example of an authentication index stored in the relevant information storage section.

FIG. 19 is a sequence diagram showing a processing flow of the digital television (see FIG. 17) and the sidebar providing server (see FIGS. 4 and 13A) in a service providing system of the another embodiment of the present invention.

FIG. 20 is a view showing a concrete example of a display data request message α that is generated by a display data request processing section of the digital television at S102 of FIG. 19.

FIG. 21 is a view showing a concrete example of display data α generated by the sidebar providing server at S104 of FIG. 19.

FIG. 22 is a view showing a concrete example of a display data request message β generated by the display data request processing section of the digital television at S109 of FIG. 19.

FIG. 23 is a view concretely showing a part of display data β generated by the sidebar providing server at S112 of FIG. 19.

FIG. 24 is a view showing a concrete example of a display data request message γ generated by the display data request processing section of the digital television at S115 of FIG. 19.

FIG. 25 is a block diagram schematically illustrating an arrangement of the digital television in another embodiment of the present invention.

FIG. 26 is a view showing a concrete example of a display screen of the digital television on which an error screen is displayed.

FIG. 27 is a view showing a concrete example of a display screen of the digital television on which a guidance screen is displayed.

FIG. 28 is a view showing another concrete example of a display screen of the digital television on which an error screen is displayed.

FIG. 29 is a flow chart showing a processing flow of the digital television of the embodiment of the present invention.

FIG. 30 is a front view of an operation section of the digital television as a remote controller.

### EXPLANATION OF REFERENCE NUMERALS

1: Digital television (information display device)
2: Sidebar providing server (information providing device)
3: Service distributing server
5: Display data request message
6: Image
7: Display data
7′: Sidebar
8: Service
9: External connection device
10: Control section
11: Tuner and demodulating section
12: TS decoder
13: AV decoder
14: Image superimposing section
15: Audio output section
16: Display section
17: Storage section
17a: Registration information (storage area)
17b: Fixed information (storage area)
17c: Authentication index
17d: Server information storage section
17e: Error screen data storage section
18: Communication section
19: Operation section
20: Temporary storage section (cache)
20a: Display data storage section
20b: State information (temporary information/storage area)
21: Interface section
30: Event processing section
31: Relevant information setting section (relevant information setting means)
32: Display data request processing section (request processing means/relevant information transmitting means)
33: Display data execution processing section (display data processing means)
34: Browser processing section
35: Data management section (data management means)
36: OSD image generating section
37: Server authentication section (server authentication means)
38: Error processing section
60: Control section
61: Communication section
61a: Receiver section
61b: Transmitter section
62: Pattern data selecting section (template selecting means/relevant information specification means)
63: Display data generation section (display data generation means/relevant information specification means)
64: Service image acquisition section
65: Relevant information acquisition section (relevant information acquisition means)
70: Request message analysis section (relevant information acquisition means)
80: Control script generation section (relevant information specification means/control script generation means)
90: Storage section
91: Pattern data storage section
92: Service image storage section
93: Common object storage section
100: Service providing system (information providing system)
130: ENTER key
131: EXIT key
132: Direction key
170: Relevant information storage section
190: Model-pattern data corresponding table (corresponding information)
191: Template storage section
192: First display data
193: Pattern data
194: Second display data

### BEST MODE FOR CARRYING OUT THE INVENTION

One embodiment of the present invention is described below with reference to the attached drawings. The present embodiment discusses an example in which an information display device of the present invention is a digital television. Further, an information providing device of the present invention is explained as a sidebar providing server for providing a sidebar function to digital televisions. The sidebar function is a tool for (i) displaying brief description information of services that are available on the digital television and (ii) activating such services. The sidebar function is described later in detail.

When a service is activated via a sidebar displayed on a digital television, contents of the service is provided to the digital television from a service distributing server of a service provider.

In the following explanation, an information providing system of the present invention is applied to a service providing system including the digital television, the sidebar providing server and the service distributing server.

However, the information display device, the information providing device and the information providing system of the present invention are not limited to the following concrete examples.

### Embodiment 1

### Outline of Service Providing System

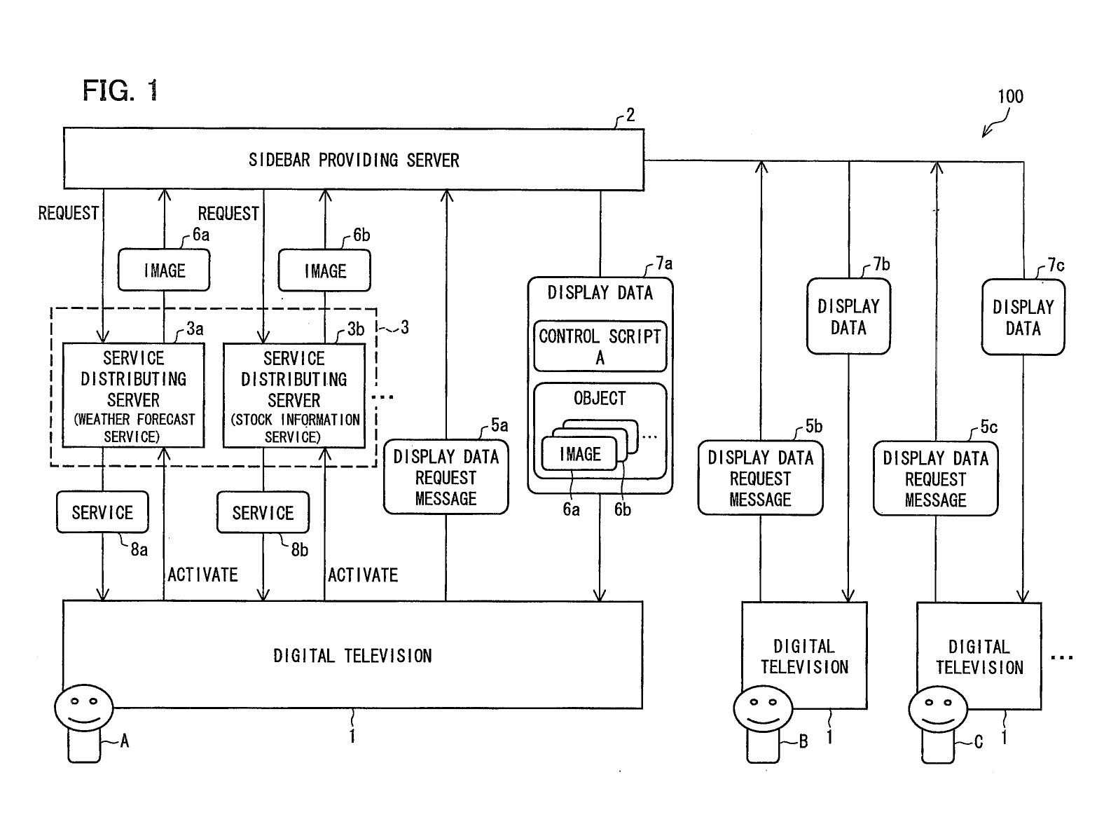

FIG. 1 is a drawing showing a schematic configuration of a service providing system 100 of an embodiment of the present invention. As shown in FIG. 1, the service providing system 100 includes a digital television 1, a sidebar providing server 2 and a service distributing server 3.

The digital television 1 carries out a sidebar function provided from the sidebar providing server 2 and uses services provided by the service distributing server 3.

The sidebar function is a function of a digital television, and the function includes a sidebar displaying function and a service launcher function. The sidebar displaying function is a function of displaying, on a corner of a screen of the digital television, brief descriptions of services which are available in the digital television, like a toolbar (OSD (On-Screen-Display)). The service launcher function is a function of activating a service displayed on the sidebar when the service is selected.

One or more than one digital television 1 requests the sidebar providing server 2 to provide display data 7 (7a, 7b, 7c . . . ) necessary for displaying, on the digital television 1, a sidebar (information object) having the above function. Specifically, the digital television 1 transmits a display data request message 5 (5a, 5b, 5c . . . ) to the sidebar providing server 2.

The sidebar providing server 2 provides the display data 7 generated specially for the digital television 1 independently, to the digital television 1 in response to the display data request message 5 transmitted from the digital television 1. The sidebar providing server 2 tailor-makes the display data 7 specially for each digital television 1 independently.

First, the sidebar providing server 2 requests the service distributing server 3 (3a, 3b . . . ), that distributes services, to provide an image 6 (6a, 6b . . . ) showing a brief description of a service to be contained in the sidebar. The sidebar providing server 2 requests the image from one or more than one service distributing server 3. How many service distributing servers 3 and which service distributing server 3 the sidebar providing server 2 requests the image from differs according to the digital television 1 requesting the sidebar. That is, the sidebar providing server 2 customizes the display data 7 (contents of the sidebar) according to the digital television 1 requesting the sidebar.

The service distributing server 3 may provide the image 6 in response to the request of the sidebar providing server 2. As an alternative, when information is updated in the service distributing server 3, the service distributing server 3 may provide, to the sidebar providing server 2, the image 6 containing the updated information.

Further, in the example shown in FIG. 1, the service distributing server 3 provides, to the sidebar providing server 2, the information containing a brief description of a service by using image-form data such as the image 6. However, a form of the data is not limited to this. For example, the service distributing server 3 may provide, in response to the request of the sidebar providing server 2, text-form data, or complex data containing image data and text data, as brief description information of a service.

The sidebar providing server 2 generates the display data 7 containing collected objects such as the image 6 and a control script for determining how the objects are displayed, and then transmits the display data 7 to the digital television 1. The digital television 1 can display a sidebar customized for the digital television 1 by analyzing and executing the display data 7. Brief description information of various services which can be used in the digital television 1 is displayed on the sidebar, and when a service is selected by a user (A, B, C . . . ), that service selected is activated.

The service distributing server 3 returns, in response to the request of the sidebar providing server 2, the image 6 showing a brief description of a service, and provides a service 8 (8a, 8b . . . ) in response to the request of the digital television 1 via the sidebar. For example, when the service distributing server 3 provides a weather forecast service, the service distributing server 3 provides the service 8a containing weather forecast information. The service distributing server 3 may be plural. Further, the service 8 may be provided to a plurality of digital televisions 1.

As described above, according to the service providing system 100, the digital television 1 can acquire, from the sidebar providing server 2, the sidebar function customized for the digital television 1 and can display the sidebar on the digital television 1. A user of the digital television 1 can easily activate desired services by using the customized sidebar.

(Digital Television)

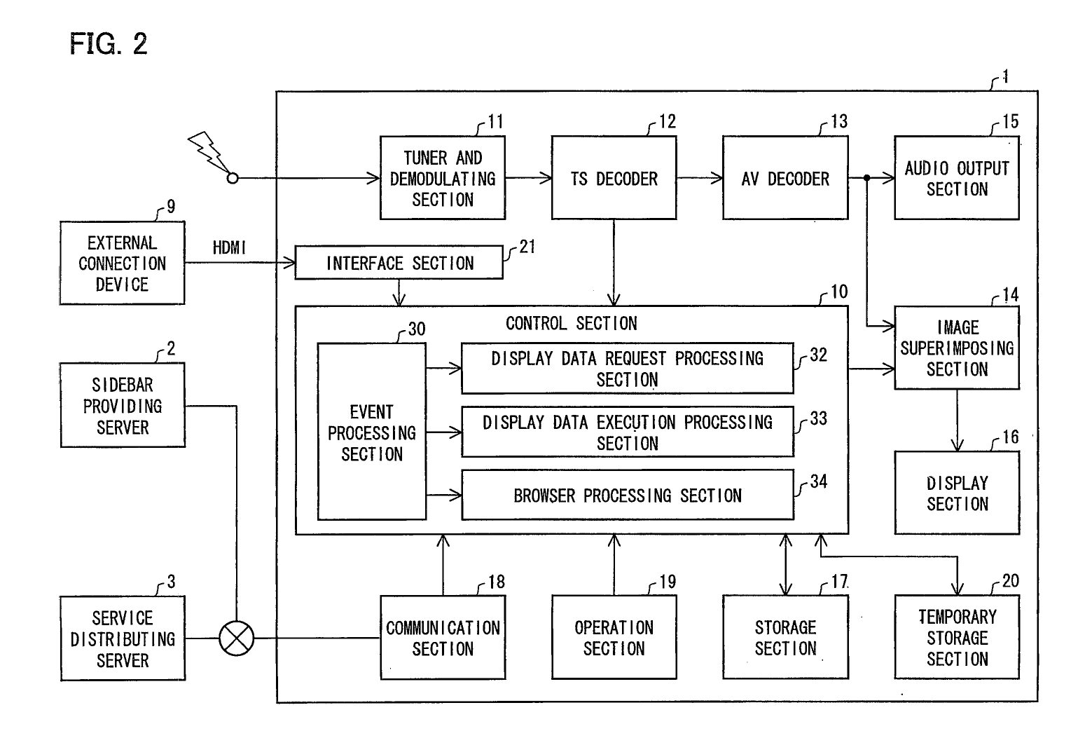

FIG. 2 is a drawing showing an example of a schematic configuration of the digital television 1 of an embodiment of the present invention. Some constituents as shown in FIG. 2 solely serve to explain general functions of a digital television and do not limit an arrangement of an information display device of the present invention.

As shown in FIG. 2, the digital television 1 includes a control section 10, a tuner and demodulating section 11, a TS (transport stream) decoder 12, an AV (audio visual) decoder 13, an image superimposing section 14, an audio output section 15, a display section 16, a communication section 18, an operation section 19, a storage section 17, a temporary storage section 20, and an interface section 21.

The control section 10 controls various kinds of operations of each section of the digital television 1. Further, the control section 10 includes, as function blocks, an event processing section 30, a display data request processing section 32, a display data execution processing section 33 and a browser processing section 34. With this arrangement, it is possible to request the display data 7 necessary for displaying a sidebar, to display an acquired sidebar, to activate services, and to display acquired services.

The tuner and demodulating section 11 for digital broadcasting carries out turning to select a digital broadcast signal supplied via an antenna from a broadcast station (not shown), performs demodulation and error correction of the received signal in accordance with a form of the signal, and forms a multiplexed digital data. The tuner and demodulating section 11 outputs the multiplexed digital data to the TS decoder 12.

The TS decoder 12 extracts a TS (transport stream) by decoding the multiplexed digital data outputted by the tuner and demodulating section 11 and separate the TS into TS packets for different purposes. The TS packets are transmitted to the AV decoder 13 or the control section 10 in accordance with the purposes. Here, the TS is a signal sequence constituted by the TS packets of the fixed length. Each TS packet may contain data signals of program information and information necessary for channel selection, in addition to video and audio signals. The TS decoder 12 separates the extracted TS into (i) TS packets (broadcast data) that contain video and audio signals and are to be outputted to the AV decoder 13 and (ii) TS packets (information data) that contain signals of various information and are to be outputted to the control section 10.

The AV decoder 13 separates the video signal and the audio signal by decoding the TS packets (broadcast data) outputted from the TS decoder 12. The AV decoder 13 outputs the video signal to the image superimposing section 14 and the audio signal to the audio output section 15.

The image superimposing section 14 outputs, to the display section 16, screen data obtained by superimposing, on the video signal decoded by the AV decoder 13, OSD (On-Screen-Display) image data (e.g., sidebar) generated by the digital television 1. This makes it possible to display a screen on which the video signal of the broadcast data and the OSD image data such as a sidebar, a channel call, a menu panel and an electronic program guide (EPG) are superimposed.

The audio output section 15 outputs audio based on the audio signal of the digital television 1. For example, the audio output signal is realized by a speaker.

The display section 16 is a display device for displaying a video and/or an image of the digital television 1. For example, the display section 16 is realized by a display device such as an LCD (liquid crystal display), a PDP (plasma display panel) or a CRT (cathode-ray tube) display.

The storage section 17 stores a control program and an OS program executed by the control section 10, and various kinds of data that is read by the control section 10 when the control section 10 carries out the display data request processing and the sidebar function. The storage section 17 is constituted by a nonvolatile storage device.

For example, a disc type storage medium such as a DVD (Digital Video Disc) and a hard disc, or a semiconductor memory such as a flash memory can be suitably used for the storage device constituting the storage section 17.

The temporary storage section 20 temporarily stores data utilized by the control section 10. The temporary storage section 20 is made of a volatile storage device. The data stored temporarily is, for example, a program read out from the storage section 17, various kinds of data, or the display data 7 acquired by the sidebar providing server 2.

The communication section 18 transmits/receives information to/from various communication devices, such as the sidebar providing server 2 and the service distributing server 3, via a communication network such as the internet. The communication section 18 is capable of, for example, transmitting the display data request message 5 to the sidebar providing server 2 and receiving, from the sidebar providing server 2, the sidebar display data 7 customized for the digital television 1. Further, the communication section 18 is capable of communicating with the service distributing server 3 via the sidebar so as to receive, from the service distributing server 3, the service 8 of a target.

The operation section 19 is an input device via which a user inputs a signal for operating the digital television 1. The present embodiment discusses, as an example, the operation section 19 that includes, for example, a remote controller for a remote control operation outside the digital television 1.

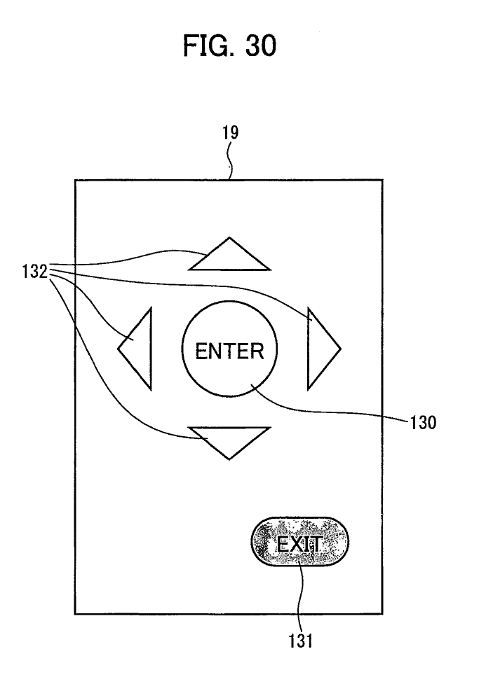

FIG. 30 shows an example of a front view of the operation section 19 serving as a remote controller. As shown in FIG. 30, the operation section includes (i) an ENTER key 130 for determining an input of instruction, (ii) an EXIT key 131 for closing a window displayed on the digital television 1 and terminating the sidebar function, and (iii) direction keys 132 for moving a cursor C displayed on the display section 16 upward, downward, leftward and rightward directions, respectively.

An arrangement of keys of the operation section 19 is not limited to this. As a remote controller for operating the digital television 1, keys of the operation section 19 may be arranged so that various functions are assigned to the keys, respectively. For example, the operation section 19 may include a numeric keypad for inputting a channel number, upper/lower buttons for an selection of a channel and a control of sound volume, a device switching button for switching a device to be used by a user, and a power button for inputting instruction to turn on or turn off power.

The digital television 1 includes, in its main body, a light receiving section (not shown) that receives an instruction signal (e.g., an infrared signal) that is inputted by a key operation on the remote controller. The instruction signal received by the light receiving section is transmitted to an input/output control section (not shown) of the control section 10. The input/output control section of the control section 10 accepts and analyzes the instruction signal that is inputted from a user into the digital television 1 via the operation section 19. Then, the instruction signal is transmitted to various sections, in need of the instruction signal, in the control section 10.

The interface section 21 performs input/output of a video signal and a control signal through, for example, an HDMI cable that is connected to an external connection device 9. The interface section 21 includes, for example, an HDMI cable terminal and an HDMI signal processing section. Examples of the external connection device 9 are a reproducing device for BD (Blue ray Disk) and an HDD (Hard Disk) recorder. The digital television 1 transmits/receives a video signal and a control signal to/from the external connection devices 9 via the interface 21, so as to display a video stored in the external connection device 9 or to store, in the external connection device 9, the video signal that the digital television 1 obtains.

The event processing section 30 of the control section 10 detects various events that occur in the digital television 1, and transmits a predetermined signal to various sections of the control section 10, for example, the display data request processing section 32 and the display data execution processing section 33. For example, the event processing section 30 detects a state such that a user presses a key of the operation section 19.

The display data request processing section 32 generates the display data request message 5 for requesting a sidebar from the sidebar providing server 2. The display data execution processing section 33 analyzes the display data 7 that is provided from the sidebar providing server 2 and displays a sidebar. The display data execution processing section 33 also accepts a selection of a service from a user and activates the service of the service distributing server 3. The browser processing section 34 processes, for example, HTML data (service 8) acquired from an external device via the communication section 18, or HTML data stored in the storage section 17 in advance, and displays information included in the data.

The display data request processing section 32, the display data execution processing section 33, and the browser processing section 34 can be realized when a CPU (central processing unit) reads out a program stored in a storage device such as a ROM (read only memory) to a RAM (random access memory) and the like and executes the program. That is, each of the display data request processing section 32, the display data execution processing section 33, and the browser processing section 34 is a function block that is realized when the CPU executes a program stored in the storage device and controls peripheral circuitry such as an input/output circuit (not shown). The control section 10 includes, as function blocks, other sections in addition to the sections above. An arrangement of the control section 10 (such sections are included) is later described in detail.

(Display Data Request Message)

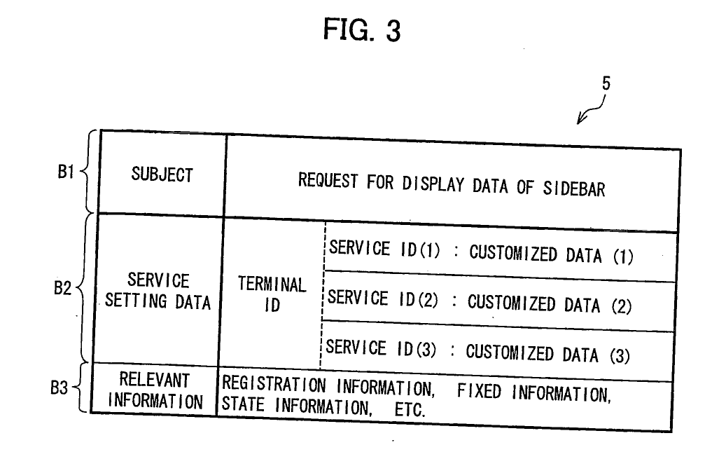

FIG. 3 is a drawing schematically illustrating a data structure of the display data request message 5 that is generated by the display data request processing section 32. In an example shown in FIG. 3, the display data request message 5 is formed as a structure including three blocks (B1 to B3) as a set. Each of the three blocks has a meaning.

A “subject” as a first block (B1) stores data indicating that the message is a message for requesting the display data 7 of the sidebar. In a case where there is no value stored in the “subject”, the sidebar providing server 2 may detect, as a default, that the message is a message for requesting the display data 7 of the sidebar.

“Service setting data” as a second block (B2) stores information (e.g., service ID) for specifying a service that a user of the digital television 1 desires to include in the sidebar. In the present embodiment, the service setting data is stored as binary data. The sidebar providing server 2 that receives the binary data takes the binary data as information that has a meaningful structure. More specifically, contents of the binary data is as follows. On the assumption that three brief descriptions of services are included in the sidebar, service IDs for the three are included in the binary data. Further, information (customization data) necessary for each of the service distributing servers 3 providing the services may be stored so as to correspond to a corresponding service ID. Further, in the present embodiment, a terminal ID for identifying the digital television 1 is associated with the three service IDs that are stored in the block. The terminal ID may be anything as long as the terminal ID allows the sidebar providing server 2 to uniquely identify each of digital televisions 1 to which the sidebar providing server 2 provides a sidebar. For example, a MAC address or a production serial number may be directly used as the terminal ID. Alternatively, an ID that the sidebar providing server 2 independently produces may be assigned as the terminal ID. According to the service setting data, the sidebar providing server 2 can specify a service (the service distributing server 3 from which the sidebar providing server 2 is to request an image) to be included in the sidebar that is to be provided to the digital television 1.

“Relevant information” as a third block (B3) stores information concerning the digital television 1. This information is independently stored in the digital television 1. The display data request processing section 32 stores, in this block, various kinds of relevant information stored in the storage section 17 or the temporary storage section 20. Details and concrete examples of the relevant information are later described. The sidebar providing server 2 is capable of customizing the sidebar according to the relevant information and generating a customized display data 7 appropriate for the digital television 1. Thus, the sidebar providing server 2 can exactly meet needs of each of digital televisions 1 and provide various kinds of display data 7.

A data type of the data of each of the blocks is selected as appropriate according to contents, capacity, and usage that are indicated by the data.

The above explanation describes the display data request message 5 as a structure including, as a set, the three blocks. However, an arrangement of the display data request message 5 is not limited to this. For example, by connecting the above terminal ID to each corresponding block, the display data request processing section 32 may separately produce each information of the “subject”, the “service setting data”, and the “relevant information” so as to transmit the information. In this case, for example, first, the “subject” that conveys a will to request the display data 7 is transmitted. Then, only the information (e.g., service setting data) necessary for the sidebar providing server 2 is generated and transmitted in response to the request from the sidebar providing server 2. This makes it possible to omit unnecessary information exchange because only the information necessary for the sidebar providing server 2 to generate the display data 7 is transmitted from the digital television 1. Further, the omission of the unnecessary information exchange reduces a risk of leakage of the relevant information. Therefore, it is preferable that the display data request processing section 32 is arranged so as to separately transmit the information when personal information of a user is included in the relevant information.

(Sidebar Providing Server)

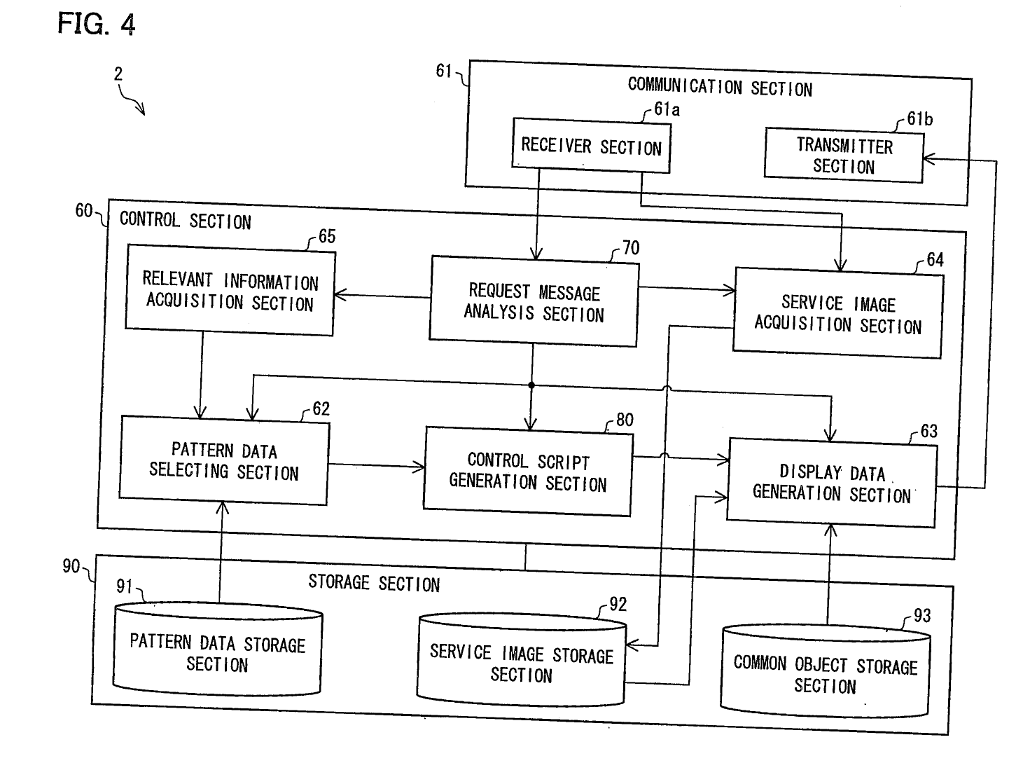

FIG. 4 is a block diagram schematically illustrating an arrangement of the sidebar providing server 2 in the embodiment of the present invention. The sidebar providing server 2, as shown in FIG. 4, includes a control section 60 that collectively controls sections of the sidebar providing server 2, a communication section 61, and a storage section 90.

The control section 60 controls various operations of the respective sections provided in the sidebar providing server 2. The control section 60 includes, as function blocks, a request message analysis section 70, a control script generation section 80, a pattern data selecting section 62, a display data generation section 63, and a service image acquisition section 64. The control section 60 reads out various programs stored in the storage section 90 and controls sections of the sidebar providing server 2 of the present invention, so as to carry out various processes for generating the display data (and a control script included in the display data).

The storage section 90 stores a control program and an OS program that the control section 60 executes, and various data that the control section 60 reads out when executing the various processes. The storage section 90 is made of an nonvolatile storage device such as a hard disk. The various data above is stored in various storage sections inside the storage section 90. In other words, the various data is stored in, for example, a pattern data storage section 91, a service image storage section 92, and a common object storage section 93. The various data stored in the storage section 90 is not limited to the data discussed above.

The communication section 61 communicates with each device of the service providing system 100 via a communication network. The communication section 61 includes a receiver section 61a and a transmitter section 61b.

Specifically, the receiver section 61a receives the display data request message 5 that is transmitted from the digital television 1. The display data request message 5 accepted via the receiver section 61a is transmitted to the request message analysis section 70 of the control section 60. Moreover, the receiver section 61a receives the image 6 that is transmitted from the service distributing server 3. The image 6 received by the receiver section 61a is transmitted to the service image acquisition section 64.

The transmitter section 61b makes a request to the service distributing server 3 for the image 6 indicative of a brief description of a service. The image 6 is necessary for producing the display data 7 requested. That is, the transmitter section 61b makes a request for the necessary image 6 to the service distributing server 3 that is designated by the service image acquisition section 64. The transmitter section 61b transmits the display data 7 generated in response to the request from the digital television 1. That is, the transmitter section 61b transmits, to the digital television 1 that has made a request, the display data 7 transmitted from the display data generation section 63.

The request message analysis section 70 analyzes the display data request message 5 transmitted from the digital television 1. For example, the request message analysis section 70 analyzes the display data request message 5 shown in FIG. 3, and transmits an analysis result (e.g., subject, service setting data, relevant information) to sections that operates for generating the display data 7.

The service image acquisition section 64 acquires an object required for generating the requested display data 7, in accordance with the analysis result of the request message analysis section 70. More specifically, the service image acquisition section 64 (i) specifies a service distributing server 3 to be requested to provide an image 6 illustrating a brief description of a required service, based on the service ID shown in the service setting data and (ii) requests the service distributing server 3 to provide such an image 6. The storage section 90 stores information regarding the service distributing server 3 to be requested to provide the image 6 in a manner such that the information corresponds to the service ID (service information storage section, not illustrated).

When the requested image 6 is received from the service distributing server 3, the service image acquisition section 64 stores the image 6 in the service image storage section 92.

The service image acquisition section 64 may request and acquire, not limited to the image 6, text-form data or complex data containing text-form and image-form data as information related to the brief description of the service. The service image storage section 92 can also store the text-form data and the complex data. The text-form data and the complex data acquired by the service image acquisition section 64 can be stored in the service image storage section 92.

The pattern data selecting section 62 selects pattern data for generating the requested display data 7 in accordance with an analysis result of the request message analysis section 70. The pattern data selecting section 62 selects, from the pattern data storage section 91, pattern data specified by the analysis result. The pattern data selected by the pattern data selecting section 62 is transmitted to the control script generation section 80 and the display data generation section 63.

The pattern data (template of display data) is data in which descriptions are made for a part (fixed part) that is common in content regardless of the digital television 1 (fixed part), in the control script which configure the display data 7 of the sidebar. Namely, the pattern data is a template of the display data 7. In the pattern data, a part other than the fixed part, that is, a part which is customized in accordance with relevant information of the digital television 1, has scripts in a state such that contents can be later embedded.

When it is specified, from the analysis result of the request message analysis section 70, that data for displaying the sidebar is requested by the digital television 1, the pattern data selecting section 62 selects pattern data appropriate for the digital television 1 which requested the data for displaying the sidebar. In the pattern data storage section 91, relevant information of digital televisions 1 is stored in association with pattern data appropriate for the relevant information. This makes it possible for the pattern data selecting section 62 to select appropriate pattern data according to the digital television 1. A concrete example of the pattern data storage section 91 is later described.

The control script generation section 80 generates a control script to be contained in the requested display data 7 by use of the pattern data selected by the pattern data selecting section 62.

The control script generation section 80 completes, in the entire control script, the control script of the part which require customizing by embedding the contents, by use of the analysis result of the request message analysis section 70 and the pattern data selected by the pattern data selecting section 62. For example, a script specifying an object (image 6) acquired from the service distributing server 3, or a script specifying a location (URL) of data that is to be accessed when the object is selected by a remote controller, is embedded in the part which require the customization.

The control script generation section 80 that completes the control script by embedding contents from the pattern data can be realized based on known techniques disclosed in Japanese Unexamined Patent Publication, Tokukai, No. 2006-24137, for example.

The display data generation section 63 generates display data specified by the display data request message 5, and transmits this display data to the digital television 1. More specifically, the display data generation section 63 generates the display data for displaying the sidebar requested by the digital television 1, by combining (for example, compiling to one file in zip form) (i) the control script generated by the control script generation section 80 and (ii) an object included in the control script, which object is specified by a script that specifies the object. The object may be: an image of a button commonly used in all sidebars; the image 6 acquired from the service distributing server 3; or the like. Images used in common are stored in the common object storage section 93. The image 6 acquired from the service distributing server 3 is stored in the service image storage section 92. The display data generation section 63 may select a common image suitable for the digital television 1 among a plurality of the common images, in accordance with the contents of the display data request message 5.

The display data generated as such includes an optimum control script and object in accordance with the request from the digital television 1, that is, the contents (service setting data or relevant information) of the display data request message 5.

According to the above arrangement, in accordance with the analysis result of the request message analysis section 70, optimum pattern data is selected by the pattern data selecting section 62, and optimum contents are specified by the control script generation section 80. Further, the image 6 constituting the sidebar is acquired by the service image acquisition section 64. This makes it possible for the sidebar providing server 2 to complete appropriate display data 7 according to the service setting data and the relevant information of the digital television 1 and to provide the display data 7 to the digital television 1. The digital television 1 can execute the sidebar function on the basis of the appropriately customized display data 7.

As described above, it is possible to customize the display data 7 for displaying the sidebar in accordance with contents of the service setting data and the relevant information of the digital television 1 which requested the display data 7 so that the digital television 1 can appropriately execute the sidebar function.

(Display Data)

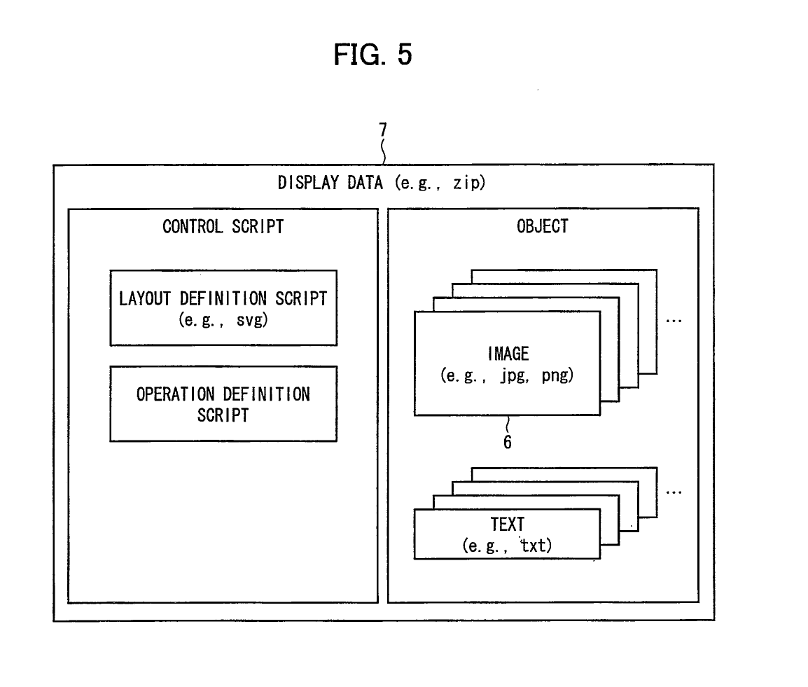

FIG. 5 is a drawing schematically showing a data structure of the display data 7 generated by the display data generation section 63. The display data 7 is information required by the digital television 1 for generating the sidebar. As shown in FIG. 5, the display data 7 in the embodiment of the present invention contains a control script and an object.

The control script specifies an operation taken when the digital television 1 carries out the sidebar function. Namely, a control instruction with respect to the digital television 1 is included in the control script. The object is data that is to be displayed on the digital television 1, and is specifically, image data in jpg or png format, text data, and the like. As described above, the object includes the image 6 acquired from the service distributing server 3 and the like. Further, in a case where information regarding a brief description of the service is displayed in a text form, text-form data may also be included. Contents of the text data may be (a) customized data generated by the display data generation section 63 in accordance with the contents of the display data request message 5, (b) data included in the pattern data selected by the pattern data selecting section 62, or (c) fixed data.

The data format of the object is not limited to the example shown in FIG. 5, and may be of any data format as long as the digital television 1 can handle the data so as to display the data on the digital television 1.

In the present embodiment, the control script is largely classified into two types.

A first type is a layout definition script, which specifies how and on which position the object is to be displayed. The layout definition script includes how the object to be displayed corresponds to layout information such as a display position and display size of the object. Due to this layout definition script, the digital television 1 knows how and where to display which object in the display data 7.

A second type is an operation definition script, which specifies contents of predetermined operations to be carried out by the digital television 1 in accordance with an event that occurs (e.g. elapse of a predetermined time, start/end of a predetermined operation, receiving display data, or remote control entering by a user) in the digital television 1. The operation definition script defines the operations of the digital television 1 in detail, for example, which of the display data 7 is to be displayed (requested and acquired) subsequently to what kind of event that has occurred. The operation definition script enables the digital television 1 to determine how to process which data at what timing to which device.

The control script may be arranged as, for example, text-form data described by XML (eXtensible Markup Language). Contents of the control script can easily be modified and provided to the digital television 1. The layout definition script may be described as, for example, SVG (Scalable Vector Graphics). A concrete example of the SVG data is later described.

As described above, modification of a description in the control script contained in the display data 7 in the sidebar providing server 2 allows easy modification of a specification of the sidebar function to be carried out by the digital television 1, without carrying out any modification to basic functions incorporated in a ROM of the digital television 1.

In an example shown in FIG. 5, the display data 7 is formed as a structure including an object to be displayed and the layout definition script. However, an arrangement of the display data 7 is not limited to this. For example, the display data 7 includes data in which only the operation definition script of the XML format is compiled to one file in zip form, for the purpose of control the digital television 1.

(Processing Flow of Service Providing System)

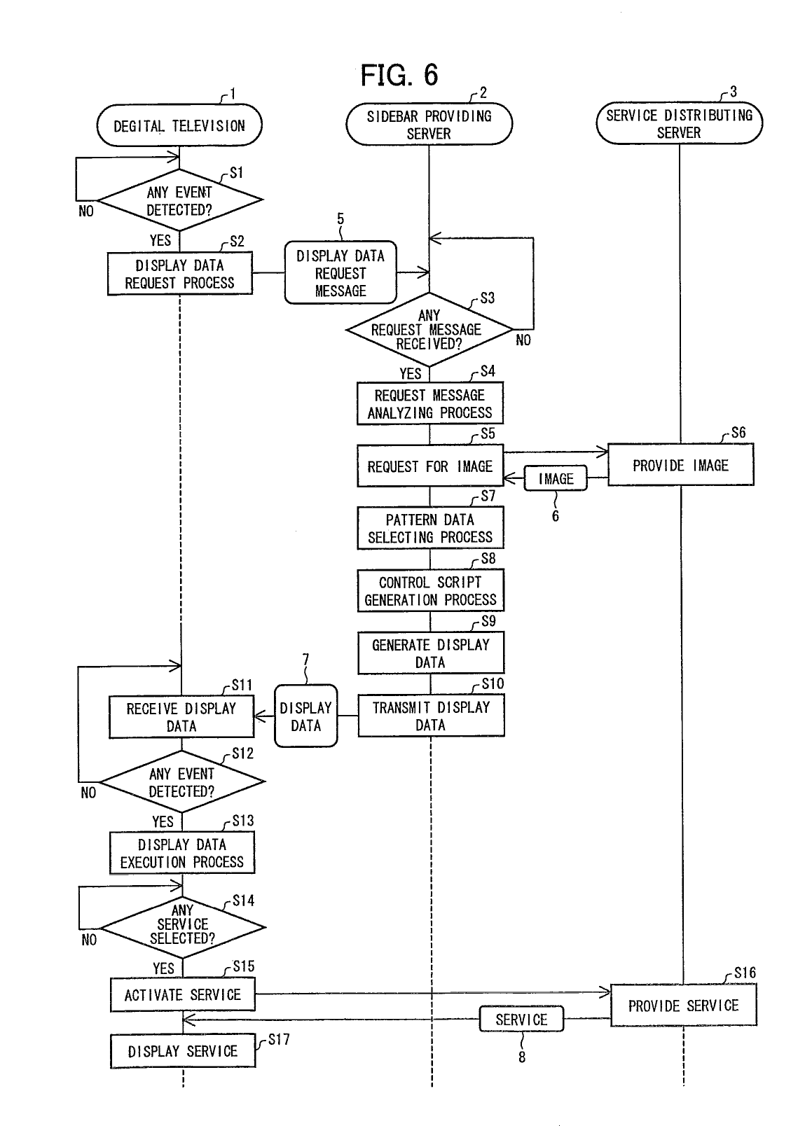

FIG. 6 is a sequence diagram showing a processing flow of each the devices in the service providing system 100 of an embodiment of the present invention.

If the event processing section 30 of the digital television 1 detects an input of instruction to display a sidebar from the operation section 19 (YES at 51), the display data request processing section 32 generates the display data request message 5 and transmits the display data request message 5 to the sidebar providing server 2 (S2).

If the sidebar providing server 2 receives the display data request message 5 from the digital television 1 (YES at S3), the request message analysis section 70 analyzes the display data request message 5 (S4).

The service image acquisition section 64 identifies a requested service based on the analysis result at the S4 and requests the service distributing server 3 for providing the service to provide an image 6 showing a brief description of the service (S5).

The service distributing server 3 provides the image 6 in response to the request at the S5 (S6).

The pattern data selecting section 62 selects, based on the analysis result at the S4, the pattern data most appropriate for generation of display data to be provided to the digital television 1 (S7).

Next, the control script generation section 80 generates, based on the selected pattern data and the acquired image 6, a control script for causing the digital television 1 to execute a sidebar function customized for the digital television 1 (S8). The display data generation section 63 generates display data including the control script generated by the control script generation section 80 and an object (S9).

Finally, the transmitter section 61b transmits the display data 7 generated at the S9 to the digital television 1 which requested the display data (S10).

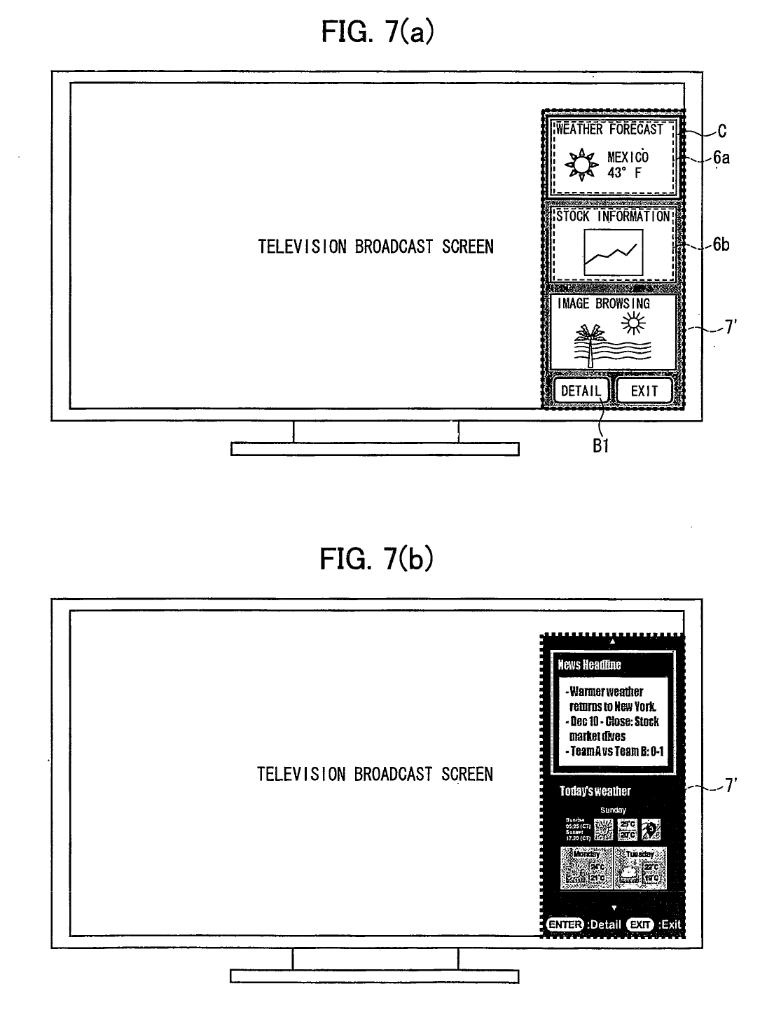

The digital television 1 receives the display data 7 from the sidebar providing server 2 (S11). If the event processing section 30 of the digital television 1 detects a predetermined event (receipt of the requested display data) (YES at S12), the display data execution processing section 33 executes processing of the received display data 7 (S13). That is, the display data execution processing section 33 displays a sidebar 7′ in accordance with the control script included in the display data 7 (see FIGS. 7 (a) and 7 (b)).

If the event processing section 30 detects selection of a DETAIL button B1 in a state where a cursor C is on an image 6a in the sidebar 7′ shown in FIGS. 7 (a) and 7 (b) (YES at S14), the display data execution processing section 33 makes a call to the browser processing section 34 and gives the browser processing section 34 instruction to activate the service in accordance with a description of the control script.

The browser processing section 34 requests the service distributing server 3 to provide a service 8 (S15).

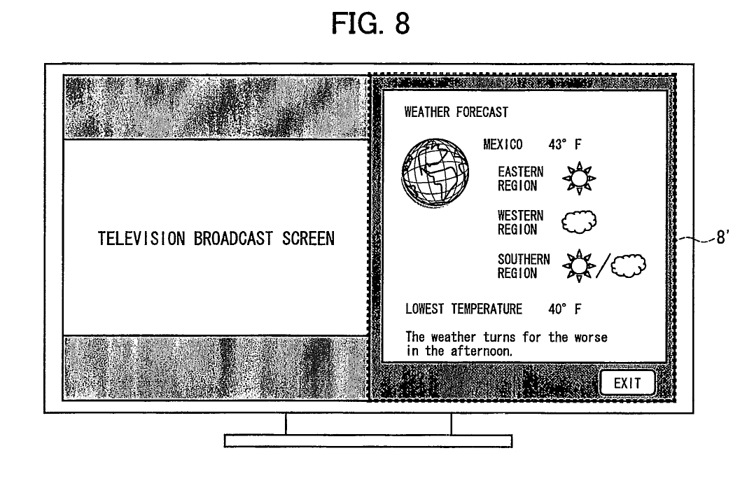

The browser processing section 34 downloads the service 8 (e.g. HTML data) from the service distributing server 3 (S16), and displays the service 8 on the display section 16 of the digital television 1 (S17) (see FIG. 8).

According to the above method, the sidebar providing server 2 can generate the display data 7 for displaying a sidebar in a manner such that the display data 7 is customized for the digital television 1 in accordance with contents (service setting data and relevant information) of the display data request message 5 transmitted from the digital television 1. The digital television 1 can execute the sidebar function customized for the digital television 1 in accordance with the control script included in the display data 7. For example, the sidebar displays a brief description of a service desired by a user, and a URL for access to the service is embedded in the sidebar. This makes it possible for the user to easily acquire a desired service by using the customized sidebar.

### Concrete Example

### Customizing Sidebar According to Model

An arrangement in which a sidebar is customized according to the digital television 1 is explained by using a concrete example. The present embodiment discusses an example in which the digital television 1 transmits model information to the sidebar providing server 2 as the relevant information of the display data request message 5, and the sidebar providing server 2 customizes a sidebar according to the model information.

(Digital Television Arrangement 1)

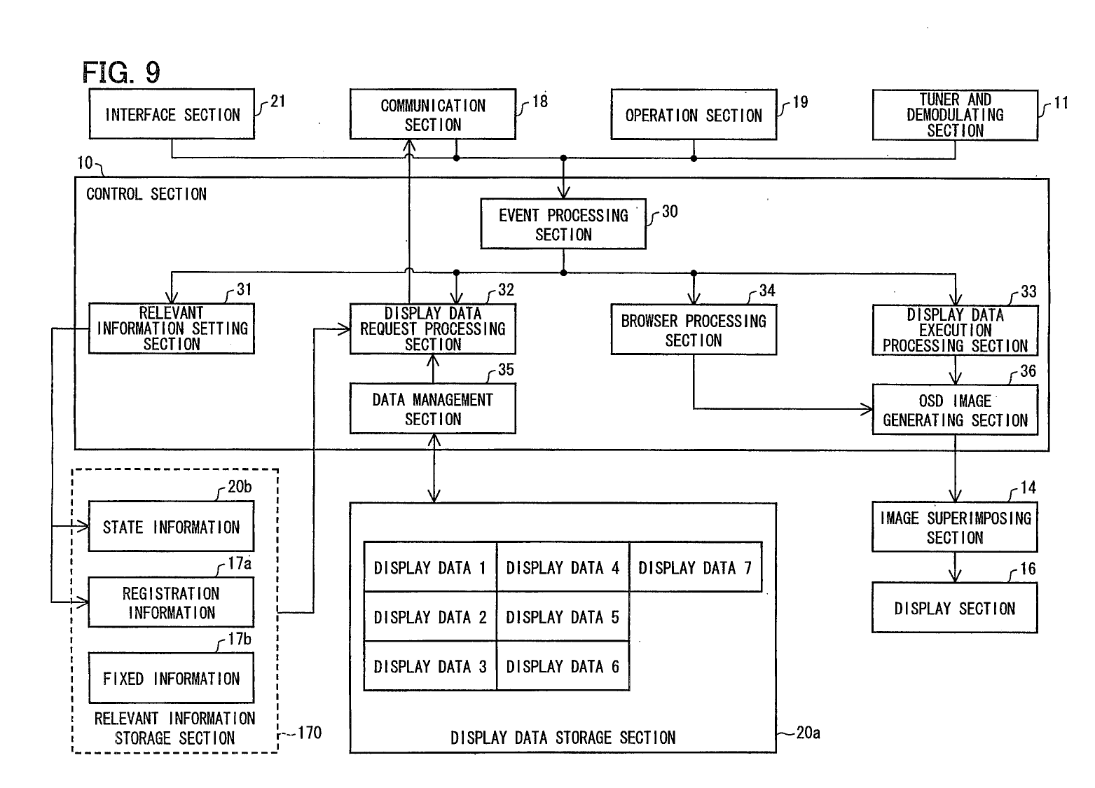

FIG. 9 is a block diagram showing a substantial part of the digital television 1 of an embodiment of the present invention. As shown in FIG. 9, the control section 10 of the digital television 1 includes, as function blocks, the event processing section 30, a relevant information setting section 31, the display data request processing section 32, the display data execution processing section 33, the browser processing section 34, a data management section 35 and an OSD image generating section 36.

Further, the digital television 1 includes a relevant information storage section 170 for storing relevant information concerning the digital television 1 and a display data storage section 20a for temporarily storing the display data 7 acquired from the sidebar providing server 2.

Constituent members which are identical to those explained above are given identical reference numerals in the following embodiments. Therefore, such members are not explained repeatedly.

The OSD image generating section 36 generates an OSD image to be superimposed on video signals of a broadcast program. The OSD image generating section 36 converts the processing result of the browser processing section 34 into an OSD image and outputs the OSD image to the image superimposing section 14. In addition, the OSD image generating section 36 generates an OSD image of channel call information, an EPG and a menu panel via which a user operates the digital television 1.

The display data request processing section 32 generates the display data request message 5 by using the relevant information stored in the relevant information storage section 170. In the present embodiment, the display data request processing section 32 stores, in the relevant information block, at least “model information” among various kinds of relevant information. The following explains the relevant information in detail with use of a concrete example.

(Relevant Information)

The relevant information includes every kind of information concerning the digital television 1. The relevant information can be classified into three groups on the basis of how the information is handled from a hardware viewpoint.

The first group is fixed information 17b. The fixed information is information that is previously burned onto a read-only memory of the digital television 1 at a manufacturing process of the digital television 1. Therefore, a user cannot alter the fixed information by means of software after shipment.

The second group is registration information 17a. The registration information is information that is stored in a predetermined area secured in a non-volatile memory. The registration information can be registered, altered and deleted by means of software after shipment. Specifically, registered in the predetermined area of the digital television 1 as the registration information is information necessary for operating the digital television 1 and information necessary for customizing the operation of the digital television 1 to a user's taste. In the present embodiment, the registration information 17a is stored in the storage section 17.

The third group is state information 20b. The state information 20b is information (temporary information) that is temporarily stored in an area temporarily secured in a volatile storage device such as the temporary storage section 20. The state information is updated every moment in accordance with an operating state of the digital television 1 (e.g. which channel is selected, or which external device the digital television 1 is connected to). In the present embodiment, the state information 20b is stored in the temporary storage section 20.

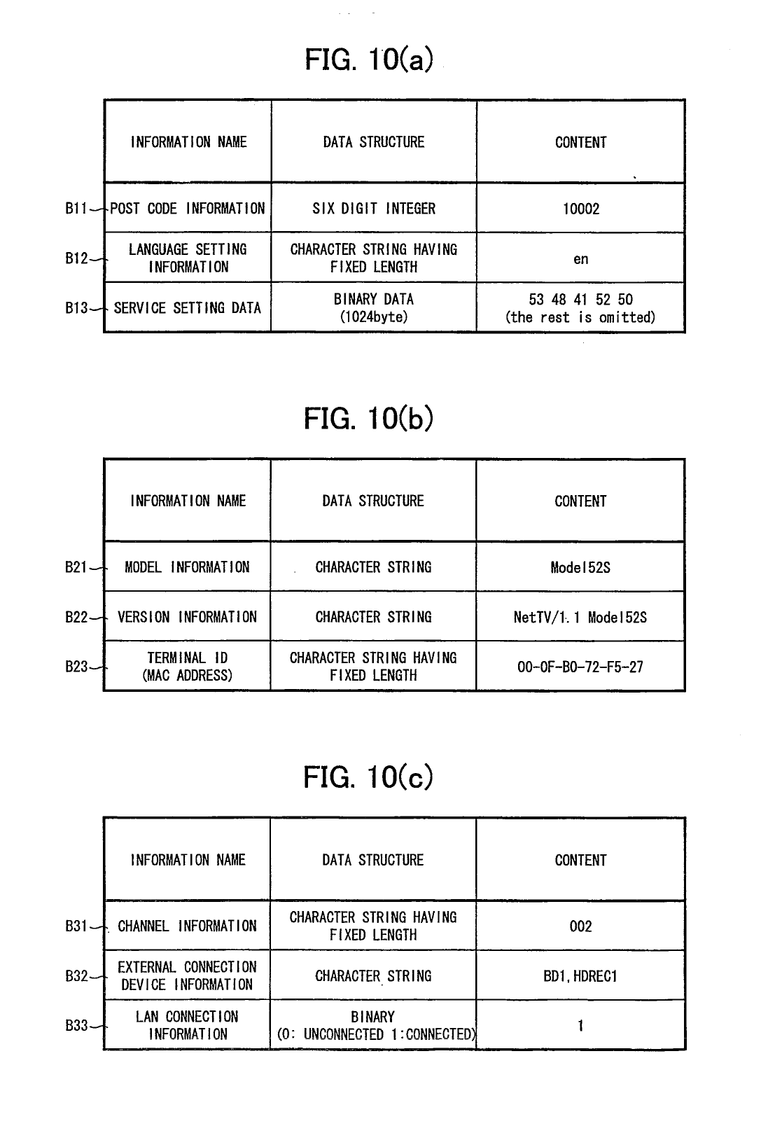

FIG. 10 (a) is a diagram showing a concrete example of the registration information 17a. The present embodiment discusses an example in which the registration information 17a has three blocks (B11 through B13), and three registration information can be registered in the registration information 17a. “Postal code information” is a block which stores a postal code of a user's living area. “Language setting information” is a block which stores setting of a language used in a menu screen and a guide screen that are displayed in the digital television 1. A user can register a language from among, for example, English (en), French (fr) and Spanish (es).

“Service setting data” is a block which stores various kinds of information which a user set concerning the sidebar function. In the present embodiment, the service setting data is in the form of binary data (fixed length of 1024 bytes). The stored binary data is read out by the display data request processing section 32 and is stored in the “service setting data” block of the display data request message 5 shown in FIG. 3.

FIG. 10 (b) is a diagram showing a concrete example of the fixed information 17b. The present embodiment discusses an example in which the fixed information 17b has three blocks (B21 through B23), and three fixed information is stored in the fixed information 17b. The “model information” is a block in which a model of the digital television is stored. “Version information” is a block in which version information of software provided in the digital television 1 is stored. “Terminal ID (MAC address)” is a block in which a MAC address of the digital television 1 is stored. In the present embodiment, the sidebar providing server 2 distinguishes the digital televisions 1 by using the MAC address.

FIG. 10 (c) is a diagram showing a concrete example of the state information 20b. The present embodiment discusses an example in which the state information 20b has three blocks (B31 through B33), and three state information is temporarily stored in the state information 20b. “Channel information” is a block in which a channel being selected and being displayed on the digital television 1 is stored. “External connection device information” is a block which stores information about which external connection device 9 the digital television 1 is connected to via the interface section 21. “LAN connection information” is a block which stores information about whether or not the communication section 18 is connected to LAN.

The display data request processing section 32 can use, other than the model information, various kinds of information described above by reading out from the relevant information storage section 170 so as to generate the display data request message 5.

A data structure of each of the relevant information shown in FIGS. 10 (a) through 10 (c) is an example, and a data structure of the relevant information used in the present invention is not limited to this. Further, the relevant information may include every kind of information related to the digital television 1 in addition to the information shown in FIGS. 10 (a) through 10 (c).

The relevant information can also be classified according to contents of the information. Specifically, the relevant information can be classified into (i) terminal information concerning functions of the digital television 1 and a terminal itself such as a MAC address, a model, the size of a display section, service setting data, and information of channel being watched and (ii) user information concerning user's personal information such as an address, a postal code, a name, a telephone number and a birthday of a user of the digital television 1. Especially the user information includes personal information which must be handled in a prudent manner. Therefore, in generating the display data request message 5 by the display data request processing section 32, it is preferable that appropriate steps are taken in order to secure security of user information from the viewpoint of personal information protection.

The relevant information setting section 31 sets editable information (the registration information 17a and the state information 20b) among the relevant information of the digital television 1 stored in the storage section 17 or the temporary storage section 20.

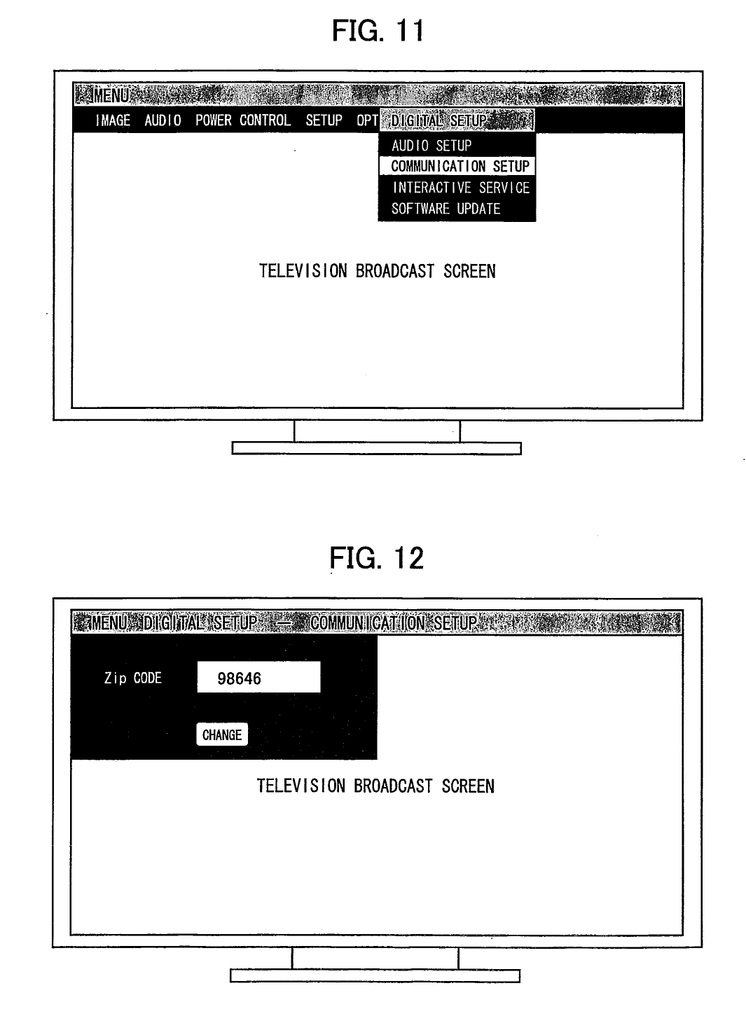

Specifically, in response to a user's input of an instruction to bring up a menu screen by using the operation section 19, the event processing section 30 detects an event of the key input and instructs the OSD image generating section 36 to output the menu screen. The OSD image generating section 36 generates the menu screen, and as shown in FIG. 11, the menu screen is displayed on the display section 16.

Further, if the user selects a menu item “communication setup” shown in FIG. 11 by operating the keys of the operation section 19, the OSD image generating section 36 generates a prompt screen for prompting the user to input a postal code (Zip code) and displays the prompt screen on the display section 16, as shown in FIG. 12.

Here, if the user inputs the Zip code and selects a CHANGE button by operating the keys of the operation section 19, the event processing section 30 detects the event and transmits, to the relevant information setting section 31, an instruction to change the registration information.

The relevant information setting section 31 stores a numeric string inputted in the prompt screen of FIG. 12 in the “postal code information” block (see FIG. 10 (a)) of the registration information 17a.

The following explains maintenance of the state information. For example, when the digital television 1 is connected to the external connection device 9 such as a BD reproducing device and an HDD recorder via an HDMI cable, the event processing section 30 detects this event via the interface section 21 and instructs the relevant information setting section 31 to update the state information.

The relevant information setting section 31 stores, in the “external connection device information” block (see FIG. 10 (c)), identification information for identifying the external connection device 9 being connected via the interface section 21. The identification information is, for example, “BD1” and “HDREC1”.

As described above, the relevant information setting section 31 maintains a state in which proper registration information and state information are always stored.

Therefore, the display data request processing section 32 can use proper information according to a state of the digital television 1 at the moment in generating the display data request message 5.

The data management section 35 manages the display data 7 temporarily stored in the display data storage section 20a. In the present embodiment, a predetermined area is secured in the display data storage section 20a in order to store seven pieces of display data. However, the number of display data is not limited to seven in particular. By the data management section 35, the display data 7 acquired via the communication section 18 is stored in the display data storage section 20a. In the present embodiment, the sidebar providing server 2 may return one display data 7 in response to one display data request message 5 sent by the digital television 1. Alternately, the sidebar providing server 2 may return a plurality of display data 7.

If the data management section 35 receives new display data 7 in a state in which data is already stored in all of the seven blocks of the display data storage section 20a, the data management section 35 deletes the old data and stores the new data in accordance with a predetermined rule. For example, the data management section 35 may delete the oldest display data 7, or may delete the display data which is not referred for the longest time.

Further, the data management section 35 carries out maintenance of the display data storage section 20a. For example, the data management section 35 keeps, for a predetermined time period, the display data 7 which should not be deleted, in accordance with the description of the control script of the display data 7. Further, the data management section 35 deletes the display data 7 which should be deleted, after a predetermined time period elapses.

This makes it possible to keep a state where only the proper display data 7 is stored in the display data storage section 20a.

Here, another arrangement is possible in which if the event processing section 30 receives an instruction to display a sidebar, the data management section 35 judges whether or not the display data 7 for displaying the requested sidebar is stored in the display data storage section 20a before the display data request processing section 32 generates the display data request message 5.

The above arrangement makes it possible for the display data execution processing section 33 to carry out the sidebar function by using the display data 7 stored in the display data storage section 20a, and thereby making it unnecessary to generate unnecessary display data request message 5 and to transmit/receive unnecessary data.

In the present embodiment, when the display data request processing section 32 only uses the model information as the relevant information, the state information 20b and the registration information 17a may not be included in the relevant information storage section 170. Therefore, the relevant information setting section 31 may not be provided, too.

As described above, the display data request processing section 32 generates the display data request message 5 including the model information stored in the relevant information storage section 170 in accordance with an instruction to display a sidebar. For example, in FIG. 10 (b), “model information: Model52S” is included in the “relevant information” block (see FIG. 3). In this way, the model information of the digital television 1 is transmitted to the sidebar providing server 2. The display data request processing section 32 may transmit, to the sidebar providing server 2, the blocks of the display data request message 5 at one time or at a plurality of times. For example, it is possible that first, the display data request processing section 32 transmits “subject” and “service setting data” to the sidebar providing server 2, and then transmit “relevant information (model information)” in response to the request of the sidebar providing server 2.

(Sidebar Providing Server Arrangement 1)

In response to receipt of the display data request message 5 from the digital television 1 by the sidebar providing server 2 shown in FIG. 4, the sidebar providing server 2 generates the display data 7 customized for the digital television 1 which requested the display data 7 and returns the display data 7 to the digital television 1. The following is a more detailed explanation.

The request message analysis section 70 analyzes the display data request message 5 transmitted via the receiver section 61a. In the present embodiment, the model information is included in the display data request message 5. Therefore, the request message analysis section 70 extracts the model information from the display data request message 5 and transmits the model information to the pattern data selecting section 62.

Alternately, the control section 60 may include the relevant information acquisition section 65 as a function block. When the model information is not included in the display data request message 5 as a result of analysis of the request message analysis section 70, the relevant information acquisition section 65 may transmit a message for requesting the digital television 1 to provide the model information so as to acquire the model information from the digital television 1. The model information acquired by the relevant information acquisition section 65 is transmitted to the pattern data selecting section 62.

The pattern data selecting section 62 acquires, from the pattern data storage section 91, pattern data having a sidebar form appropriate for the digital television 1 on the basis of the acquired model information (“model information: Model52S”).

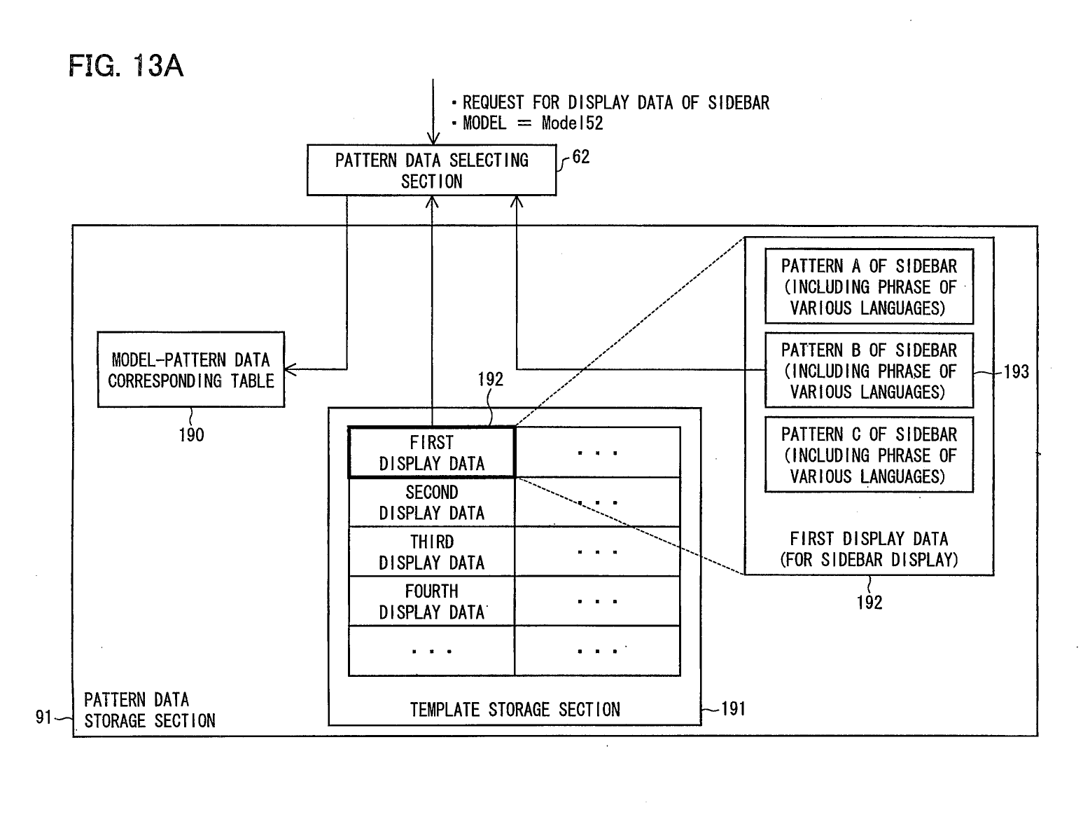

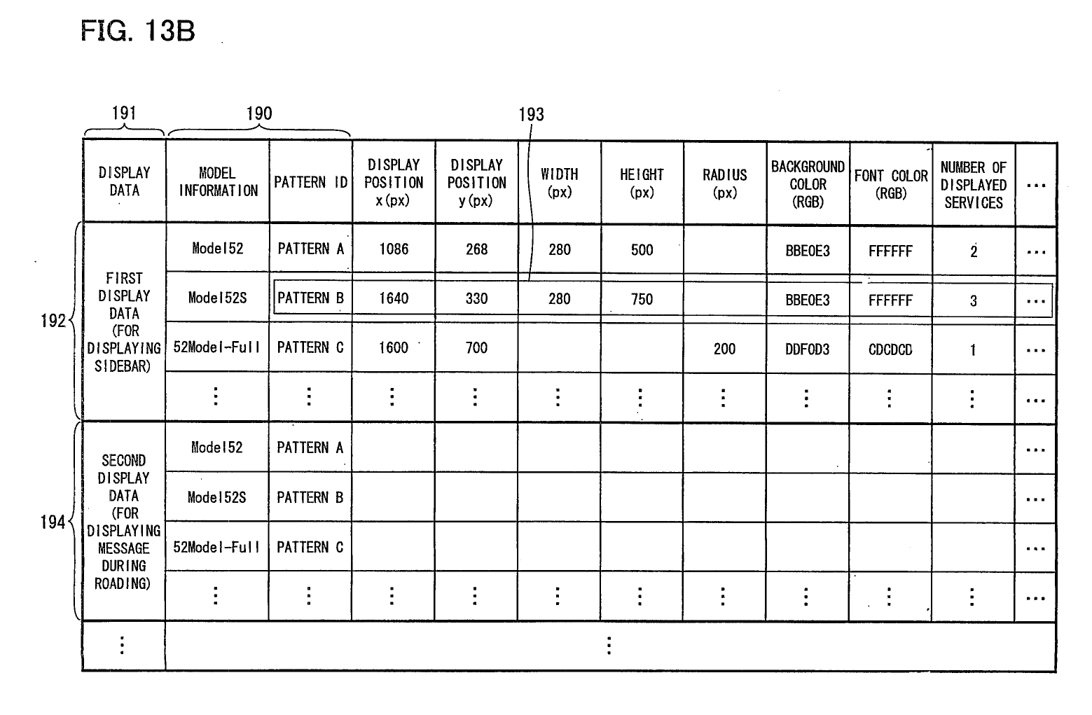

FIG. 13A is a diagram explaining an operation of the pattern data selecting section 62 for selecting pattern data by using data stored in the pattern data storage section 91.

First, the pattern data selecting section 62 receives the analysis result of the display data request message 5 from the request message analysis section 70. This makes it possible for the pattern data selecting section 62 to understand that the display data 7 “for displaying a sidebar” and for “model=Model52S” is required.

Therefore, the pattern data selecting section 62 selects first display data 192 for displaying a sidebar from a template storage section 191 in which a template of each of the display data is stored. Furthermore, the first display data 192 is associated with a script patterned according to a model.

Here, the pattern data selecting section 62 refers to a model-pattern data corresponding table 190. For example, “pattern ID: pattern B” is stored in the corresponding table 190 in a manner such that the “pattern ID: pattern B” corresponds to the “model=Model52S”.

The pattern data selecting section 62 selects, based on the corresponding table 190, pattern data 193 of the pattern B corresponding to the “model=Model52S” acquired from the request message analysis section 70.

As described above, the pattern data selecting section 62 acquires the first display data 192 for displaying the sidebar, selects the pattern data 193 of the pattern B for “Model52S”, and transmits the pattern data 193 to the control script generation section 80.

The control script generation section 80 can generate a control script to be included in the display data 7 for displaying the sidebar appropriate for the digital television 1 by using the first display data 192 (template) of the pattern B.

FIG. 13B is a view showing a concrete example of various kinds of data stored in the pattern data storage section 91.

First, the pattern data selecting section 62 acquires, from the template storage section 191, information of the first display data 192 for displaying the sidebar, in accordance with the analysis result of the request message analysis section 70. As shown in FIG. 13B, three pattern data (pattern A through pattern C) is associated with the first display data 192.

As shown in FIG. 13B, a pattern ID for identifying pattern data is stored in the model-pattern data corresponding table 190 in a manner such that the pattern ID corresponds to the model information. In an example shown in FIG. 13B, the “pattern B” is stored so as to correspond to the “model=Model52S”. Therefore, the pattern data selecting section 62 selects the pattern data of the “pattern B” based on the model information.

This makes it possible to identify the pattern data 193 of the pattern B which should be used in generating the display data 7. The pattern data is uniquely identified from the pattern ID and the template of display data. That is, information such as a shape, color and size of a sidebar and where and how many service are displayed is patterned and stored in a manner such that the information corresponds to the display data and the pattern ID. The control script generation section 80 utilizes SVG data of a fixed form, the SVG data being formed in accordance with the patterned information or being stored in advance.

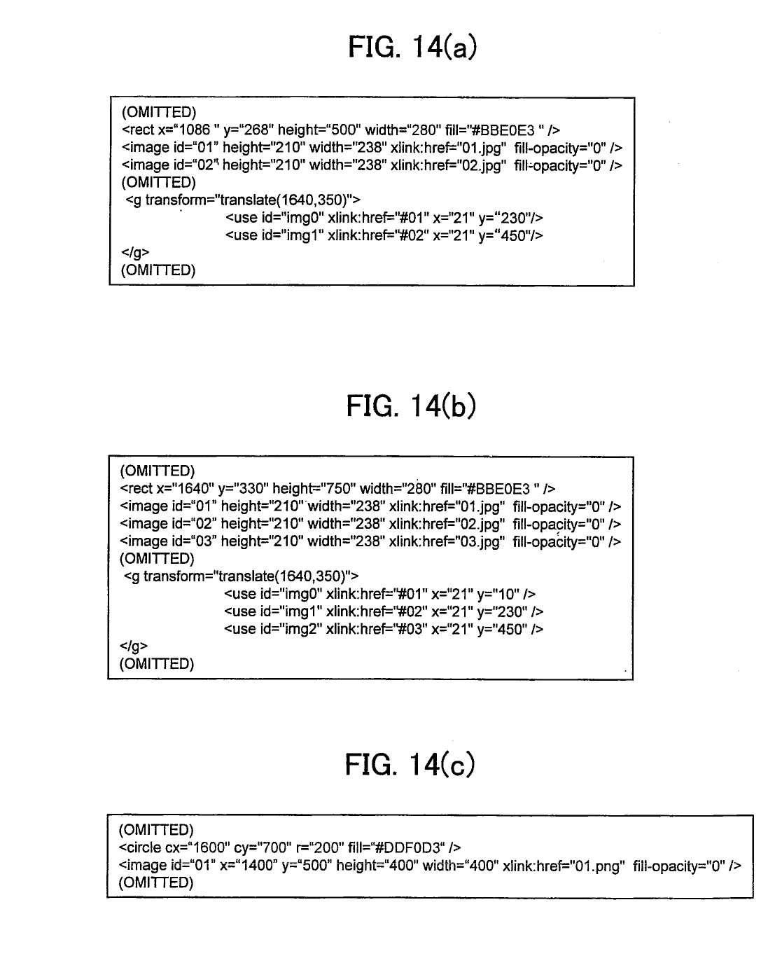

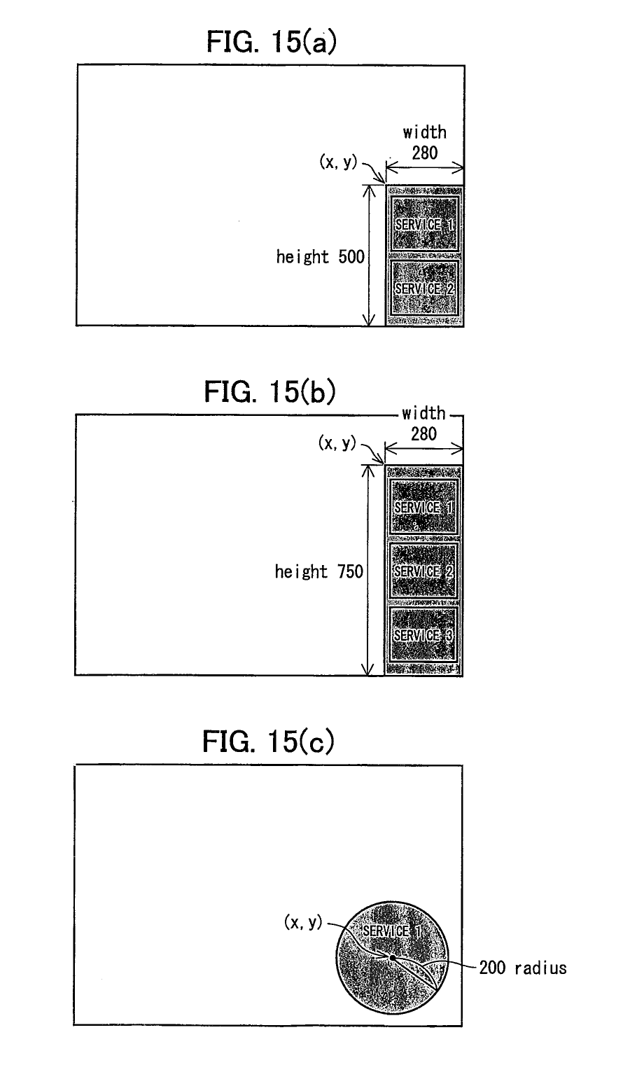

FIGS. 14 (a) through 14 (c) are views each concretely showing a part of the three pattern data (SVG data of a fixed form) shown in FIG. 13B. FIGS. 15 (a) through 15 (c) are views each concretely showing a shape and size of a sidebar and the number of services displayed in a case in which the digital television 1 displays the sidebar on the display section 16 in accordance with the respective SVG data shown in FIGS. 14 (a) through 14 (c).

When the SVG data shown in FIG. 14 (a) is supplied to the digital television 1, the digital television 1 processes the SVG data thus supplied and displays a sidebar of the position, size, shape and the number of services shown in FIG. 15 (a). When the SVG data shown in FIG. 14 (b) is supplied to the digital television 1, the digital television 1 processes the SVG data thus supplied and displays a sidebar of the position, size, shape and the number of services shown in FIG. 15 (b). When the SVG data shown in FIG. 14 (c) is supplied to the digital television 1, the digital television 1 processes the SVG data and displays a sidebar of the position, size, shape and the number of services shown in FIG. 15 (c).

In this way, the pattern data selecting section 62 selects appropriate pattern data according to the model information of the digital television 1. This makes it possible for the control script generation section 80 to generate a control script most appropriate for the digital television 1.

Therefore, the sidebar providing server 2 can provide, to each of digital televisions 1, the most appropriate sidebar according to models of the digital televisions 1. That is, it is possible to display a sidebar of any color, any shape and any size in any position.

For example, there is a difference according to the models of the digital television 1 in where an OSD image such as a channel call and a menu screen is displayed. Therefore, when a sidebar is displayed in a uniform size and a uniform position (e.g. lower right portion of the screen), an OSD image (e.g. channel call) and the sidebar may overlap with each other in some models. This causes problems (e.g. deterioration in operability, or deterioration in viewability of information) for a user.

Therefore, by customizing, for each of the models, a position in which a sidebar is displayed, it is possible to provide the SVG data so that a sidebar and other OSD images do not overlap with each other.

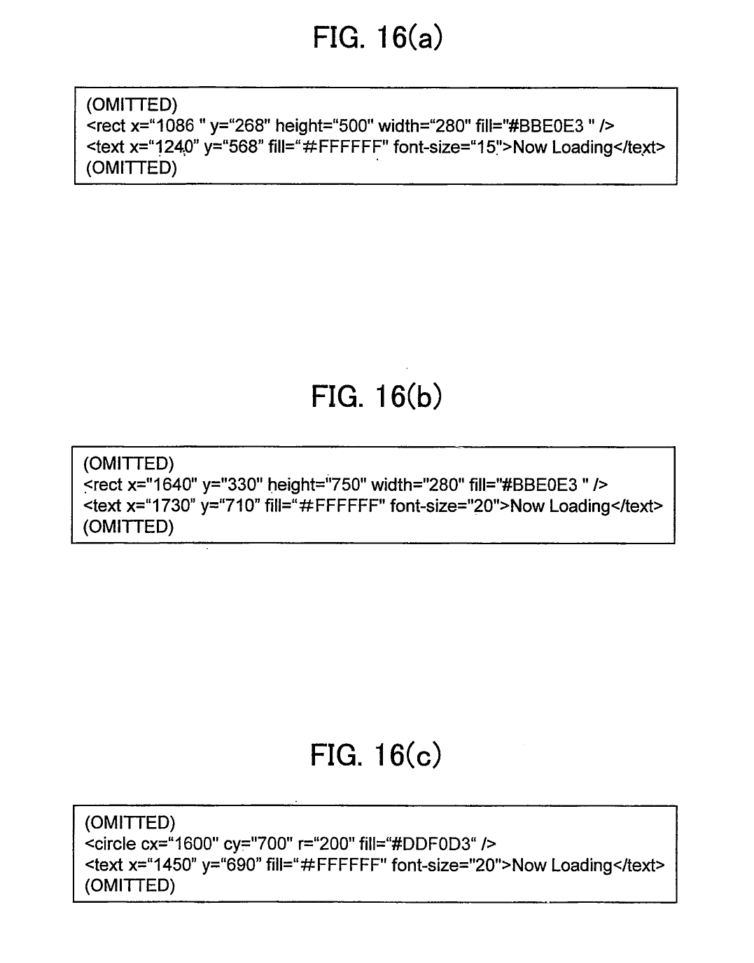

When the second display data 194 (see FIG. 13A) of the template storage section 191 is display data for displaying a message which notifies that a sidebar is being loaded (second display data 194 shown in FIG. 13B), the second display data 194 is associated with three SVG data of fixed form shown in FIGS. 16 (a) through 16 (c).

### Embodiment 2

The following description deals with an arrangement of the service providing system 100 in which the display data request message 5 for requesting the display data 7 of a sidebar is transmitted at a plurality of times. More specifically, the following description deals with an arrangement in which only “subject” (message for requesting the display data 7 of the sidebar) is transmitted to the sidebar providing server 2, and then the “relevant information” is transmitted to the sidebar providing server 2 in response to the request of the sidebar providing server 2.

(Digital Television Arrangement 2)

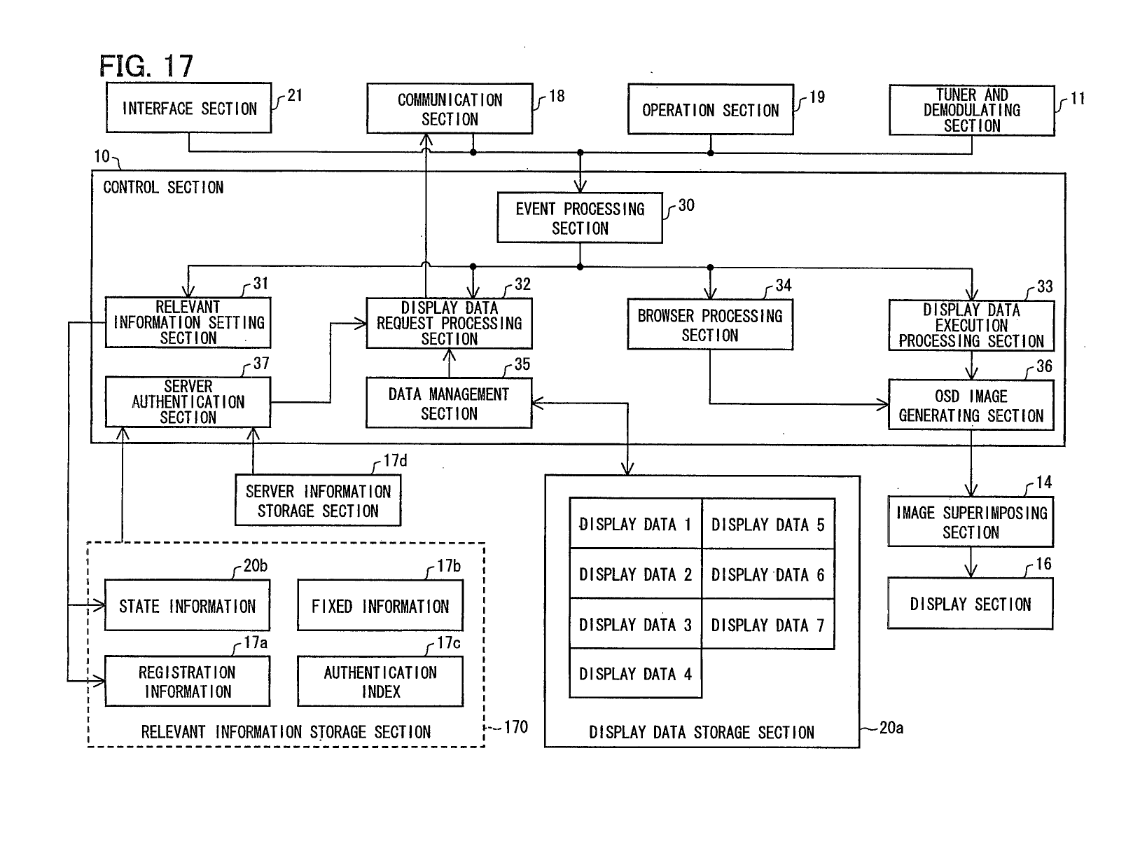

FIG. 17 is a block diagram showing a substantial part of the digital television 1 of an embodiment of the present invention.

In the present embodiment, the display data request processing section 32 receives, from a user, an instruction to display a sidebar, and then transmits, as a first display data request message 5, “subject” (see FIG. 3) information for requesting the sidebar.

Then, the display data request processing section 32 transmits only the service setting data that is requested by the sidebar providing server 2 or only other relevant information as a second (third . . . ) display data request message 5.

Here, the sidebar providing server 2 transmits, to the digital television 1, the display data 7 including a control script which orders the digital television 1 to transmit some of the relevant information registered in the relevant information storage section 170 by the relevant information setting section 31.

Thus, it is only necessary that, only when requested by the sidebar providing server 2, the display data request processing section 32 of the digital television 1 transmits the requested relevant information in accordance with the control script.

According to the above arrangement, it is unnecessary for the digital television 1 to judge which information should be included in the display data request message 5 when generating the display data request message 5. This makes it possible to simplify the arrangement of the digital television 1.

Furthermore, a control script instructs to return the relevant information (e.g. postal code) registered in the relevant information storage section 170. This makes it unnecessary for a user to input a postal code requested by the sidebar providing server 2. Therefore, it is possible to simplify user's operations. This is especially effective in the service providing system 100 for providing a sidebar.

A sidebar displays brief descriptions of a plurality of services. Therefore, each of the brief descriptions is also customized according to the digital television 1. Each of the brief descriptions is customized specially for each of the services. For example, when three services are displayed in the sidebar, there is a case in which three service distributing servers 3 require the relevant information (e.g. postal code). In this case, a user must input a postal code three times in order to customize each of the services. Therefore, user's operations become complicated.

However, according to the above arrangement, it is only necessary to acquire a postal code registered in the digital television 1 and to transmit the postal code in response to the request of the sidebar providing server 2, in accordance with a control script transmitted from the sidebar providing server 2. This makes it unnecessary for the user to input the postal code three times and to carry out a complicated operation.

Further, the sidebar providing server 2 for providing the sidebar and the service distributing server 3 for providing the service can use the postal code in customizing information relevant to a living area of a user of the digital television 1 and providing the customized information to the digital television 1. The information relevant to the living area of the user includes weather information, community event information, advertisement information of local stores, and official information of a local government.

Furthermore, in the present embodiment, before the digital television 1 transmits the relevant information in response to the request of the sidebar providing server 2, the digital television 1 can judge whether or not the sidebar providing server 2 which requested the relevant information is reliable. As described above, the relevant information transmitted from the digital television 1 to the sidebar providing server 2 includes the user information concerning information about a user. Further, information of high commercial value (e.g. audience rating information, information about what kind of service are used) can be easily acquired by collecting the channel information and service setting data. Therefore, it is preferable that such secrete information is under a high level of security. The following description deals with an embodiment of the digital television 1 which transmits the relevant information only to reliable sidebar providing servers 2.

The digital television 1 of FIG. 17 is different from that of FIG. 9 in that (i) the control section 10 further includes a server authentication section 37 and a server information storage section 17d, and (ii) the relevant information storage section 170 further includes an authentication index 17c.

Furthermore, in the present embodiment, when the data management section 35 receives the display data 7 from an external device such as the sidebar providing server 2, the data management section 35 stores the display data 7 in the display data storage section 20a in a manner such that the display data 7 is in association with a domain name of a sender of the display data 7. Similarly, when the data management section 35 receives a plurality of display data 7 at one time, the data management section stores the display data 7 in the display data storage section 20a in a manner such that the display data 7 is, respectively, in association with domain names of senders of the display data 7. This makes it possible for the digital television 1 to confirm the sender of the display data 7 before processing any of the display data 7 stored in the display data storage section 20a.

The server authentication section 37 authenticates the sidebar providing server 2 which requests the relevant information, and judges whether the sidebar providing server 2 is reliable or not.

A list of domain names of reliable communication partners (sidebar providing server 2) is stored in the server information storage section 17d in advance. The server authentication section 37 judges whether or not a sender of the display data 7 for requesting the relevant information is a reliable server by comparing a domain name of the sender with domain names included in the list stored in the server information storage section 17d. A method for identifying a domain name is not limited in particular. The server authentication section 37 may perform a full text search or may perform a suffix search in order to judge whether or not a server which transmitted the display data 7 is a reliable server.

Further, another arrangement is adoptable in which the list of the domain names is not stored in the server information storage section 17d, but the server authentication section 37 acquires the list of the domain names of the reliable servers from another reliable server which is guaranteed by a third party such as a certificate authority.

As described above, only when the server authentication section 37 judges that a server which requested the relevant information is a reliable sidebar providing server 2, the display data request processing section 32 transmits, to the sidebar providing server 2, subsequent display data request messages 5 including the relevant information.

As above, when the display data request messages 5 are not transmitted at one time but transmitted at a plurality of times, it is possible to authenticate the servers which request the relevant information, and then to transmit the secret information only to the reliable servers.

Furthermore, instead of the digital television 1, the sidebar providing server 2 judges whether or not the relevant information of the digital television 1 should be transmitted to the sidebar providing server 2. Therefore, in the service providing system 100, it is possible to flexibly change the relevant information to be utilized, only by changing a specification of the sidebar providing server 2. That is, there is no need for a change in a specification of the digital television 1. This makes it possible to simplify maintenance of the whole service providing system 100.

Not all relevant information stored in the relevant information storage section 170 of the digital television 1 is the secret information. Therefore, another arrangement is possible in which the server authentication section 37 confirms whether or not the requested relevant information requires authentication of servers before authenticating the servers.

The relevant information storage section 170 further stores the authentication index 17c. The authentication index 17c is information showing which relevant information is the secret information that is required to be transmitted only to the reliable sidebar providing servers 2. That is, the authentication index 17c is information showing which relevant information requires an access control.

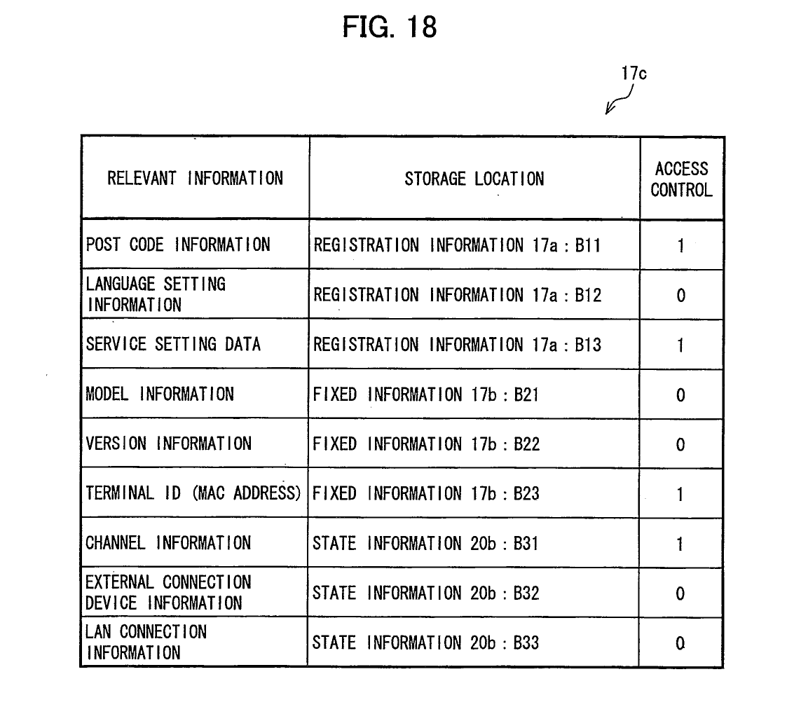

FIG. 18 shows an example of the authentication index 17c. As shown in FIG. 18, flags indicating whether the access control is required or not are stored in the authentication index 17c in a manner such that the flags are associated with the relevant information, respectively. If the relevant information to which “1” is assigned in the field of “ACCESS CONTROL” is requested, the server authentication section 37 judges whether a server which requested the relevant information is reliable or not. In the example shown in FIG. 18, the server authentication section 37 judges whether a server which requested the relevant information is reliable or not, only when the “postal code information”, the “service setting data”, the “terminal ID (MAC address)”, and the “channel information” are requested.

Thus, based on the authentication index 17c, the server authentication section 37 can appropriately perform the access control only to the secret information which requires prudent handling.

As a result, only the sidebar providing server 2 can know the secret information of the digital television 1. This makes it possible to realize the service providing system 100 in which security of the secret information of the digital television 1 is guaranteed. Furthermore, it is possible to develop a business model. For example, the information of commercially high value is processed and utilized through a proper procedure so as to provide the information to the service distributing server 3 with charge.

Further, in the service providing system 100 of the present embodiment, the sidebar providing server 2 can control how the digital television 1 handles the display data 7 acquired from the sidebar providing server 2. More specifically, the operation definition script of the control script is arranged so as to specify how the digital television 1 should handle the display data 7, for example, when to request new display data 7, how to store the received display data 7, and when to delete the acquired display data 7. When the display data 7 including such control script is supplied to the digital television 1, the sidebar providing server 2 can control how the digital television operates.

For example, the sidebar providing server 2 may transmit a control script specifying that the digital television 1 requests new display data 7 for displaying the sidebar after a predetermined time period (e.g. one minute) elapses. Further, when a description specifying that “request the display data 7 for displaying the sidebar after one minute” is always included in the display data 7 for displaying the sidebar, the sidebar providing server 2 can cause the digital television 1 to operate so as to update the sidebar every one minute.

[Processing Flow of Service Providing System]

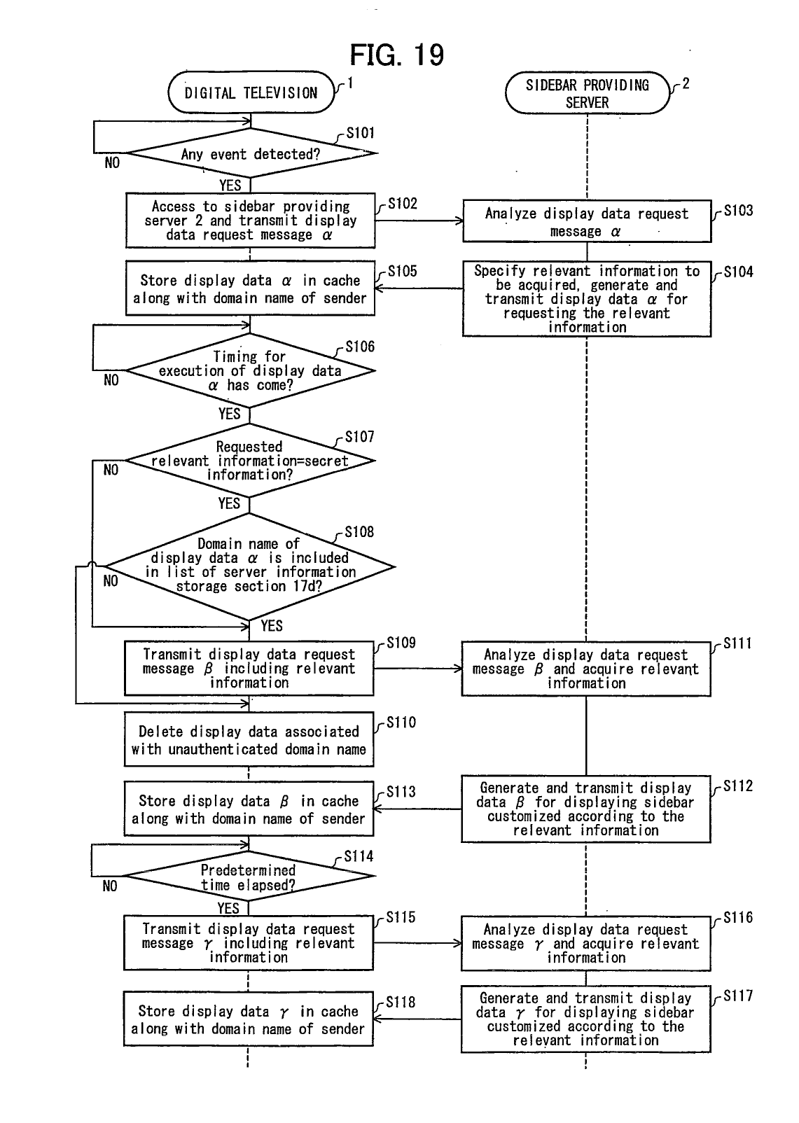

FIG. 19 is a sequence chart showing a processing flow of the digital television 1 (see FIG. 17) and the sidebar providing server 2 (see FIGS. 4 and 13A) in the service providing system 100 of the embodiment of the present invention.

If the event processing section 30 of the digital television 1 detects, from the operation section 19, an input of instruction to display a sidebar (YES at S101), the display data request processing section 32 generates the display data request message 5, connects to the sidebar providing server 2, and transmits the display data request message 5 to the sidebar providing server 2 (S102). This first display data request message 5 (hereinafter referred to as display data request message α) is a message for requesting the sidebar, but does not include the relevant information necessary for the sidebar providing server 2 to generate the sidebar. The display data request message α is a message for requesting display data α, and the display data α is a message for requesting the relevant information necessary for the sidebar providing server 2.

When the sidebar providing server 2 receives the display data request message α from the digital television 1, the request message analysis section 70 analyzes the received display data request message α (S103).

In accordance with the analysis result of the request message analysis section 70, each of the pattern data selecting section 62, the control script generation section 80, and the display data generation section 63 specifies the relevant information to be acquired, generates the display data α for requesting the relevant information, and transmits the display data α (S104).

More specifically, the pattern data selecting section 62 acquires, from the template storage section 191, a template of the display data α for acquiring and requesting the relevant information of the digital television 1. The template storage section 191 is included in the pattern data storage section 91. After the template is acquired, the control script generation section 80 and the display data generation section 63 generate the display data α on the basis of the acquired template. The transmitter section 61b transmits the display data α to the digital television 1. The relevant information that is requested by the sidebar providing server 2 includes at least the service setting data. The sidebar providing server 2 may request other relevant information (e.g. postal code information) if necessary. Which relevant information is requested may be predetermined, or may be selected by the sidebar providing server 2 on the basis of a predetermined rule, in accordance with a situation (or in accordance with the display data request message α).

When the communication section 18 of the digital television 1 receives the display data α that is transmitted from the sidebar providing server 2, the data management section 35 stores the display data α in the display data storage section 20a (hereinafter referred to as cache) in a manner such that the display data α corresponds to a domain name of a sender of the display data α (S105).

If the display data execution processing section 33 judges that it is time to execute the display data α stored in the cache (YES at S106), the server authentication section 37 refers to the authentication index 17c, and judges whether or not the relevant information required in the display data α is the secret information to be access-controlled (S107). Here, for example, if the requested relevant information is the service setting data, the server authentication section 37 judges that the requested relevant information is the secret information to be access-controlled (YES at the S107), and examines the domain name. That is, the server authentication section 37 judges whether the domain name corresponding to the display data α is included in a list of the domain names of the reliable servers (S108). The list is stored in the server information storage section 17d.

If the server authentication section 37 judges that the domain name corresponding to the display data α matches with one of the domain names of the list (the server authentication section 37 can perform a full text search or a suffix search) (YES at the S108), the display data request processing section 32 generates a display data request message 5 (hereinafter referred to as display data request message β) which includes the requested relevant information (service setting data) in response to the request of the display data α, and transmits the display data request message β to the sidebar providing server 2 (S109).

On the other hand, if the server authentication section 37 judges that the domain name corresponding to the display data α does not match with any one of the domain names of the list (NO at the S108), the data management section 35 can delete the display data corresponding to the unauthorized domain name (S110).

If the server authentication section 37 judges that the requested relevant information is not the secret information (No at the S107), the authentication processing by the server authentication section 37 is not performed, and the display data request processing section 32 generates the display data request message β which includes the relevant information, and transmits the display data request message β (S109).

After the display data request message β which includes the relevant information is transmitted from the digital television 1 in response to the display data α, the request message analysis section 70 analyses the received display data request message β, and transmits the service setting data (if there is relevant information other than the service setting data, the relevant information is transmitted, too) to the service image acquisition section 64, the pattern data selecting section 62, the control script generation section 80 and the display data generation section 63 (S111).

Each of the sections which received the analysis result operates as described above so as to generate second display data (hereinafter referred to as display data β) for displaying the sidebar, and transmit the display data β to the digital television 1 (S112). The display data β is customized according to the relevant information.

The data management section 35 of the digital television 1 stores the display data β in the cache along with the domain name of the sender of the display data β (S113). A control script of the display data β may include the operation definition script specifying how the digital television 1 operates in order to regularly update the sidebar displayed by the display data β. The display data execution processing section 33 of the digital television 1 detects elapse of a predetermined time (YES at S114). This allows the display data request processing section 32 to generate the third display data request message 5 (hereinafter referred to as display data request message γ) along with the relevant information, and transmit the display data request message γ to the sidebar providing server 2 (S115). When the predetermined time elapsed at the S114, the server authentication section 37 judges whether the server which transmitted the display data β is reliable or not before the display data request processing section 32 generates and transmits the display data request message γ. The procedure for the judgment is as described above, and therefore is not explained repeatedly. According to the above method, even if the processing of executing the display data stored in the cache includes the processing of transmitting the relevant information to the sidebar providing server 2, the server authentication section 37 authenticates the server which receives the relevant information, before transmitting the relevant information to the sidebar providing server 2. Therefore, even if display data transmitted from a third-party server with evil intent is stored in the cache by mistake, it is possible to prevent the digital television 1 from transmitting the relevant information (especially, the secrete information) to the third-party server on the basis of the stored display data.

When the sidebar providing server 2 receives the display data request message γ, the received display data request message γ is analyzed, and the relevant information is transmitted to the sections in a manner similar to that described above (S116). Each of the pattern data selecting section 62, the control script generation section 80 and the display data generation section 63 generates display data γ for displaying an updated sidebar, and transmits the display data γ to the digital television 1, in a manner similar to that described above (S117). The display data γ is customized according to the relevant information.

The digital television 1 stores the display data γ for displaying the updated sidebar in the cache along with the domain name of the sender of the display data γ, processes the display data γ, and operates in accordance with a control script of the display data γ in a manner similar to that described above (S118).

Here, the sidebar providing server 2 can cause the control script of the display data β, the display data γ . . . to include the operation definition script specifying operation of the regular updating. Thus, every time the digital television 1 receives the display data for displaying the updated sidebar, the digital television 1 always requests an update of the sidebar in accordance with the operation definition script. Therefore, the service providing system 100 can be arranged such that the latest information is always displayed on the sidebar by regularly updating contents displayed on the sidebar.

Further, in the present embodiment, when the display data request processing section 32 acquires, from the storage section 17, the relevant information to be included in the display data request message 5, the display data request processing section 32 caches the acquired relevant information (e.g. service setting data) in the temporary storage section 20.

According to the above arrangement, it is possible to acquire the relevant information necessary for generating the display data request message 5 immediately from the temporary storage section 20. Therefore, it is unnecessary to read out the relevant information from the storage section 17. As described above, when it is desired to regularly update the sidebar, it is necessary to regularly generate and transmit the display data request message 5 including the relevant information. In such a case, it is possible to immediately generate the display data request message 5 without reading out the relevant information from the storage section 17. This allows an improvement in processing efficiency of the regular updating in the digital television 1.

In the above explanation, one display data 7 is transmitted for one display data request message 5. However, a plurality of display data may be transmitted to the digital television 1 at once. The data management section 35 of the digital television 1 stores the plurality of the display data in the display data storage section 20a (cache) in a manner such that each of the plurality of display data is associated with a corresponding domain name of a sender of the display data.

Further, the data management section 35 performs maintenance of inside of the display data storage section 20a so that only display data 7 associated with the same domain name is stored in the display data storage section 20a.

More specifically, the data management section 35 compares a domain name associated with new display data 7 to be stored in the display data storage section 20a and domain names associated with old display data 7 that is already stored in the display data storage section 20a. If the stored display data 7 is associated with domain names that are different from the new domain name, such display data 7 is deleted from the display data storage section 20a.

When display data 7 transmitted from different servers is mixedly stored in the display data storage section 20a, there is a possibility that display data from an unintended server is executed, and the relevant information is transmitted to the unintended server by mistake. That is, there is a possibility that the secrete information is leaked. Therefore, it is not preferable from security point of view. According to the above arrangement, display data 7 transmitted from different servers is not mixedly stored in the display data storage section 20a. This makes it possible to solve the above problem.

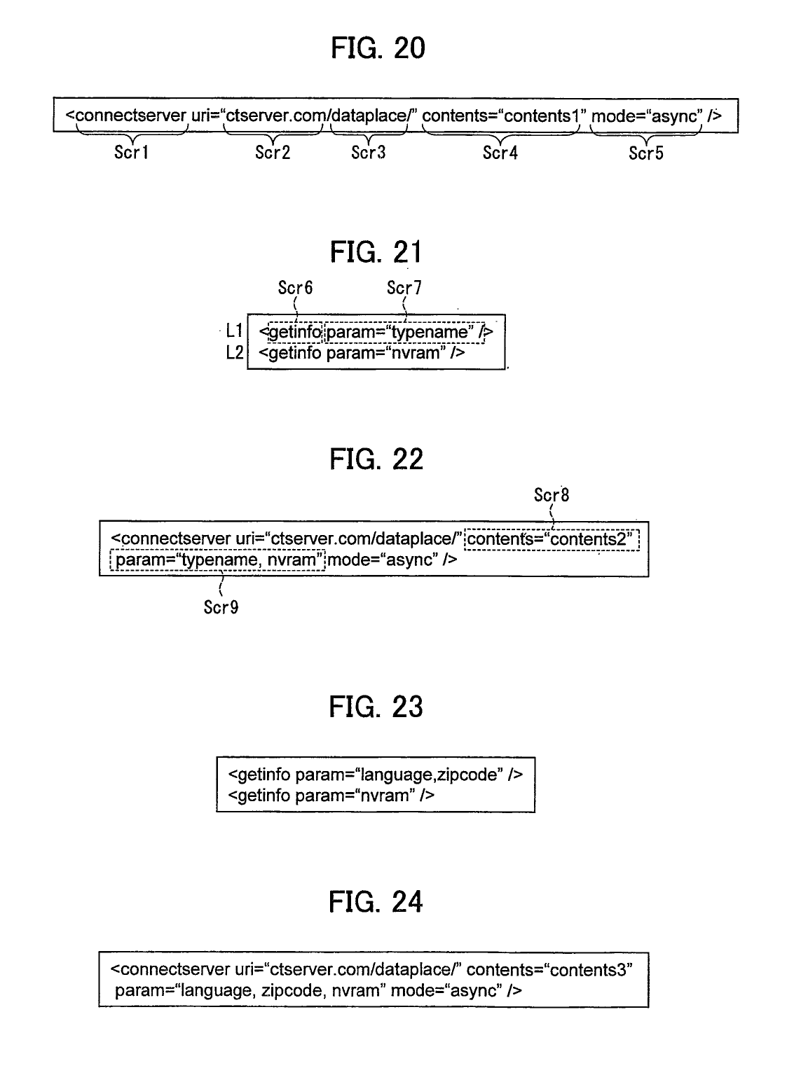

FIG. 20 is a view showing a concrete example of the display data request message α that is generated by the display data request processing section 32 of the digital television 1 at the S102.

A script Scr1 is a tag for connecting to a server, a script Scr2 indicates a name of the server, and a script Scr3 indicates a location of data to be requested. A script Scr4 indicates contents to be requested to the server. Here, “contents1” indicates that the display data a is being requested. A script Scr5 specifies which communication method is used, that is, synchronous communication or asynchronous communication. “sync” indicates the synchronous communication, and “async” indicates the asynchronous communication.

The digital television 1 is arranged so as to execute, one by one, the operation definition script included in each of the display data 7 of the display data storage section 20a. That is, the digital television 1 operates in accordance with an operation definition script for initial connection. The operation definition script for initial connection orders the digital television 1 to “request the sidebar providing server 2 to provide the display data α”. More specifically, in response to user's input of an instruction to display a sidebar by using the operation section 19, the digital television 1 executes the operation definition script for initial connection that is stored in the storage section 17, generates the display data request message α, and transmits the display data request message α shown in FIG. 20 to the sidebar providing server 2 when the digital television 1 starts the sidebar function.

FIG. 21 is a view showing a concrete example of the display data a generated by the sidebar providing server 2 at the S104.

A script Scr6 is a tag for acquiring the relevant information of a digital television. A script Scr7 specifies which relevant information is to be acquired. For example, a line L1 is a script for acquiring the model information of the digital television 1, and a line L2 is a script for acquiring the service setting data. The relevant information acquired by executing the scripts is stored in the relevant information storage section 170.

FIG. 22 is a view showing a concrete example of the display data request message β generated by the display data request processing section 32 of the digital television 1 at the S109.

A script Scr8 indicates that the display data β is being requested from a server. A script Scr9 indicates that the relevant information (the service setting data and the model information) acquired in accordance with the display data α shown in FIG. 21 is read out from the relevant information storage section 170, and is transmitted.

If the data management section 35 judges that the display data β to be requested is already stored in the display data storage section 20a, it is unnecessary for the display data request processing section 32 to generate the display data request message β.

FIG. 23 is a view concretely showing a part of display data β generated by the sidebar providing section 2 at the S112.

The display data β is display data for displaying a sidebar, but may further include a request message for acquiring other necessary relevant information, as shown in FIG. 23.

A script shown in FIG. 23 indicates that the language setting information and the postal code information is being requested, as the relevant information, from the digital television 1 along with the service setting data.

FIG. 24 is a view showing a concrete example of the display data request message γ generated by the display data request processing section 32 of the digital television 1 at the S115.

A script shown in FIG. 24 includes a message for requesting the server to provide the display data γ and the relevant information (service setting data, and language setting information, postal code information) acquired from the cache in accordance with the display data β of FIG. 23.

### Embodiment 3

The following description deals with an arrangement of the digital television 1 which provides a user with information of an error that is caused while the digital television 1 receives, from the user, an instruction to display a sidebar and displays the sidebar.

[Digital Television Arrangement 3]

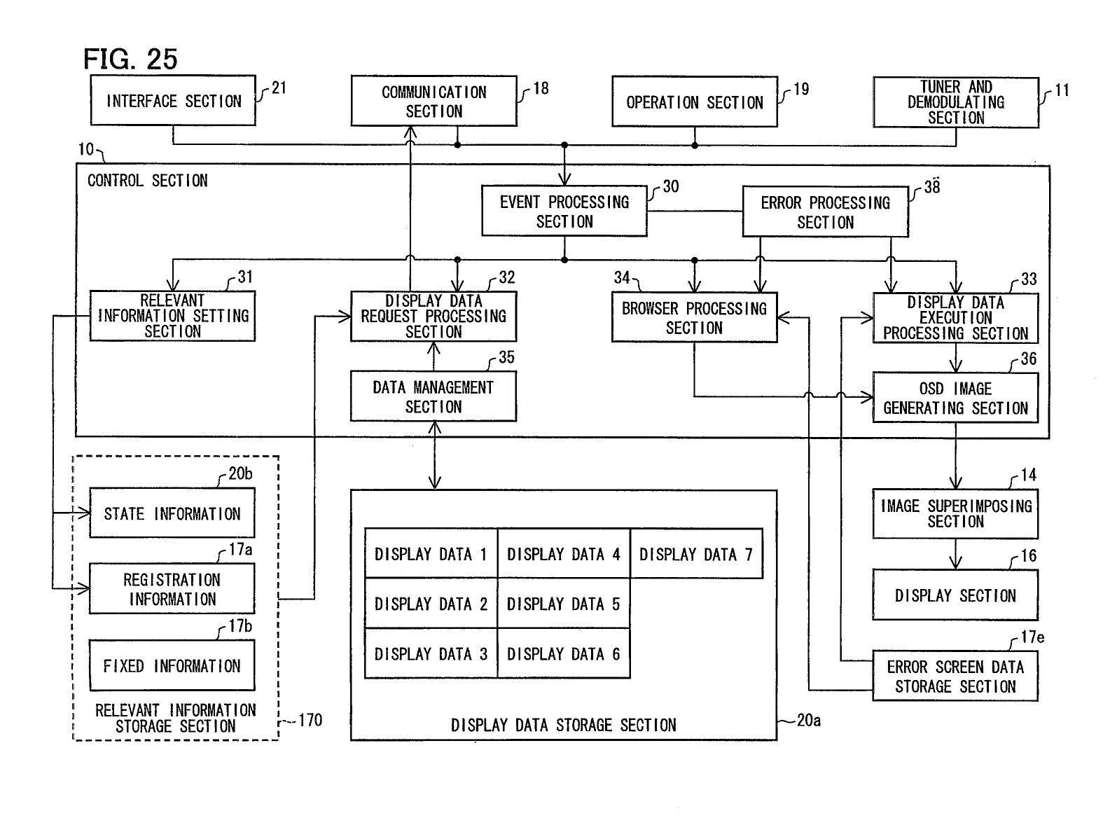

FIG. 25 is a block diagram showing a substantial part of the digital television 1 of an embodiment of the present invention.

The digital television 1 of the present embodiment shown in FIG. 25 is different from that of FIG. 9 in that the control section 10 further includes an error processing section 38 and an error screen data storage section 17e.

The error processing section 38 detects an error caused while the digital television 1 receives, from a user, an instruction to display a sidebar and displays the sidebar, and the error processing section 38 provides the user with information concerning the error.

More specifically, the error processing section 38 outputs, to the display section 16, information containing a cause of the error and a recovery method, in accordance with contents of the detected error, with use of the display data execution processing section 33 or the browser processing section 34.

In the error screen data storage section 17e, errors that may arise are classified into several groups according to contents of the errors. The error screen data storage section 17e stores error screen data for generating screens which displays a cause of an error and a recovery method in a manner such that the error screen data corresponds to the groups, respectively. A file format of the error screen data is not limited in particular. The present embodiment discusses an example in which the error screen data storage section 17e stores error screen data constituted by (i) error screen data in HTML format which data can be handled by the browser processing section 34 and (ii) the display data 7 which can be handled by the display data execution processing section 33.

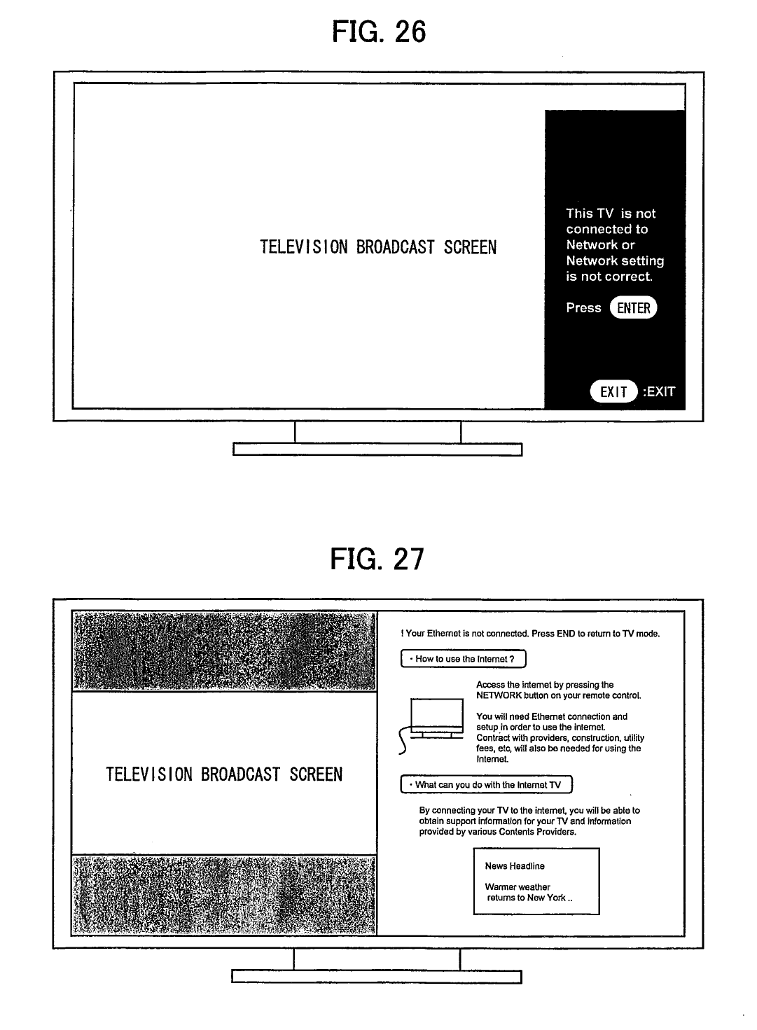

Specifically, the error screen data storage section 17e stores error screen data indicating that LAN is not connected. This error screen data corresponds to a network failure caused when LAN is not properly connected. For example, it is possible that a communication cable necessary for connection between the communication section 18 and network is not connected, or network setting is not correct. This error screen data is stored as the display data 7. The display data execution processing section 33 processes the error screen data. As a result, an error screen shown in FIG. 26 is displayed in the display section 16.

A control script of the display data 7 includes the operation definition script specifying that a guidance screen showing a procedure for recovering the network failure is brought up when a user pushes a predetermined key (e.g. ENTER key 130 shown in FIG. 30) of the operation section 19 in a state in which the error screen shown in FIG. 26 is being displayed.

Data of this guidance screen is also stored in the error screen data storage section 17e as one of the error screen data. This guidance screen may be described in HTML format. When the guidance screen is brought up by operation of a user, the browser processing section 34 processes the guidance screen by reading out from the error screen data storage section 17e so as to display the guidance screen on the display section 16. FIG. 27 is a drawing showing a concrete example of the guidance screen. The guidance screen has information volume which cannot be contained in an area for displaying a sidebar. Therefore, when the guidance screen is displayed, an area for displaying the guidance screen is made larger than the area for displaying the sidebar so that the user can more easily understand the recovery procedure of the network failure.

Here, when the browser processing section 34 displays the guidance screen for showing details of the recovery method, it is preferable that the browser processing section 34 outputs the guidance screen in a manner such that the guidance screen does not overlap with a screen on which a television program is displayed, and the user can see the television program. Specifically, the size of the screen on which the television program is displayed is reduced to such a degree that the reduction does not prevent the user from watching the television program, and a space for the display section 16 is secured in order to display the guidance screen as large as possible. This makes it possible to provide the user with detailed information concerning the recovery method of the failure without preventing the user from watching the television program.

Further, when the screen on which the television program is displayed is made smaller, it is preferable that an aspect ratio of the screen is maintained. This makes it possible to solve a problem that a change of the aspect ratio prevents the user from watching the television program.

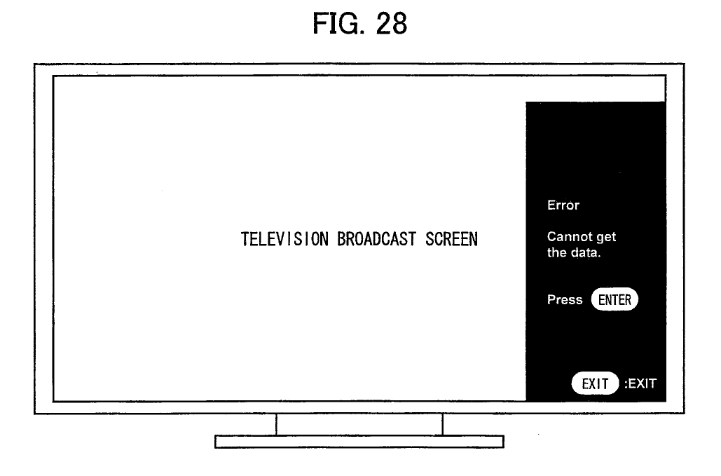

Further, the error screen data storage section 17e stores error screen data indicating server down. This error screen data corresponds to a network failure caused when the sidebar providing server 2 which supplies the display data is not normally operating although LAN is properly connected. This error screen data is stored as the display data 7. When the display data execution processing section 33 processes the error screen data, an error screen shown in FIG. 28 is displayed in the display section 16.

A control script of the display data 7 includes the operation definition script which specifies that the browser processing section 34 is called for and connects to predetermined another server when a user pushes a predetermined key (e.g. ENTER key) of the operation section 19 in a state in which the error screen shown in FIG. 28 is being displayed.

Here, if the browser processing section 34 can successfully access to the another server, the browser processing section 34 displays data (e.g. HTML data) acquired from the another server on the display section 16. This makes it possible for the user to clearly understand that a cause of the failure does not lie in the digital television 1, but lies in the sidebar providing server 2.

The another server to be connected by the above procedure when it is impossible to access to the sidebar providing server 2 is not limited in particular. For example, the another server may be a portal site, a server which runs a search engine site, or a server which distributes a digest version of a service of a service distributing server 3 (e.g. sidebar).

By setting another server to be accessed when it is impossible to access to a target sidebar providing server 2, it is possible to display alternative information instead of a target sidebar on the digital television 1. The server to be accessed as an alternative to the target sidebar providing server 2 may be predetermined and be stored in the storage section 17, or may be determined by a user and be registered in the storage section 17. Alternatively, the alternative server may be dynamically determined according to contents of a sidebar that the user tried to acquire.

(Processing Flow of Digital Television)

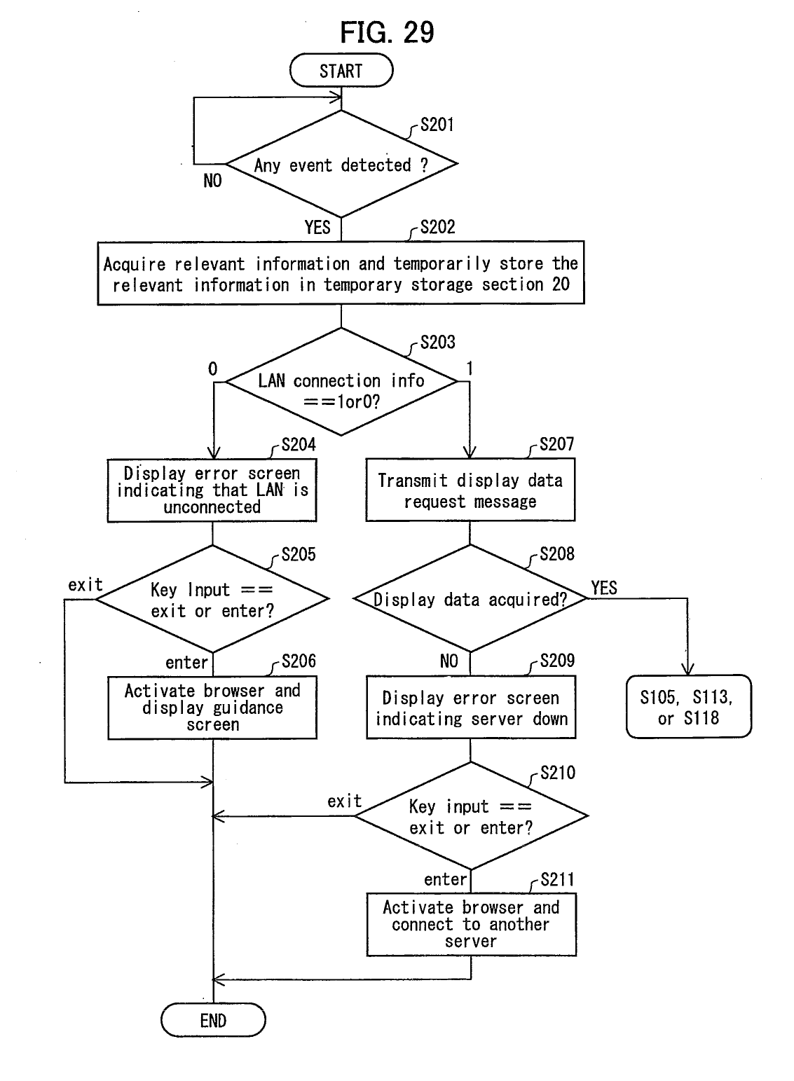

FIG. 29 is a flow chart showing a processing flow of the digital television 1 of the embodiment of the present invention.

If the event processing section 30 of the digital television 1 detects an event (e.g. an input of instruction to display a sidebar from the operation section 19, and elapse of a predetermined time) (YES at S201), the display data request processing section 32 acquires the relevant information from the relevant information storage section 170, and temporarily stores the relevant information in the temporary storage section 20 (S202). Next, the error processing section 38 judges, based on LAN connection information (0: unconnected, 1: connected) in the relevant information stored in the temporary storage section 20, whether or not the digital television is connected to LAN (S203).

Here, if the error processing section 38 judges that the digital television 1 is connected to LAN (0 at the S203), the error processing section 38 instructs the display data execution processing section 33 to display the error screen shown in FIG. 26 on the display section 16. The display data execution processing section 33 processes the error screen data stored in the error screen data storage section 17e, and displays the error screen on the display section 16 (S204). The error screen displays a cause for a network failure (e.g. a communication cable for connecting to network not being connected, or network setting not being correct).

When a user pushes the ENTER key 130 of the operation section 19 (enter at 5205) while the error screen is displayed, the event processing section 30 detects an event of the ENTER key being pushed. In accordance with the detection of the event by the event processing section 30, the browser processing section 34 displays a guidance screen (e.g. see FIG. 27) showing details of a recovery method (S206). Here, it is preferable that the browser processing section 34 secures a space in the display section 16 so that the guidance screen is displayed as large as possible. The space is secured by reducing the size of a screen on which a television program is displayed, to such a degree that the reduction does not prevent the user from watching the television program. When the user pushes the EXIT key 131 (exit at the S205) while the error screen is displayed, processing of displaying the sidebar is completed.

On the other hand, if the error processing section 38 judges that the digital television 1 is connected to LAN (1 at the S203), the display data request processing section 32 generates the display data request message 5, accesses to the sidebar providing server 2, and transmits the display data request message 5 to the sidebar providing server 2 (S207).

Then, if the communication section 18 acquires the display data 7 in accordance with the display data request message 5 (YES at S208), the acquired display data 7 is properly processed (e.g. S105, S113 or S118 of FIG. 19).

On the other hand, when the communication section 18 cannot detect the sidebar providing server 2 to be accessed, or when a time-out error occurs before reception of target display data 7 (NO at S208), the error processing section 38 instructs the display data execution processing section 33 to display the error screen shown in FIG. 28 on the display section 16. The display data execution processing section 33 processes the error screen data stored in the error screen data storage section 17e, and displays the error screen on the display section 16 (S209). The error screen displays a cause for the network failure (e.g. target data not being acquired). In this case, the cause does not relate to communication connection.

When the user pushes the ENTER key 130 of the operation section 19 (enter at 5210) while the error screen is displayed, the event processing section 30 detects an event of the ENTER key being pushed. In accordance with the detection of the event by the event processing section 30, the browser processing section 34 accesses predetermined another server which is different from the sidebar providing server 2 (S211). The browser processing section 34 displays data provided by the another server in the browser.

According to the above method, it is possible to send the user an appropriate error message in accordance with contents of a failure causing a problem that the sidebar cannot be properly acquired. Further, if the failure can be solved by the user himself, it is possible to send the user a guidance message for solving the failure. This message allows the user to know whether or not the user himself can solve the failure. If the failure is a failure the user can solve, the message allows the user to know how to solve the failure. As a result, this allows an increase in the level of convenience for the user.

Further, when the network failure is solved, it is desirable to return to normal display data request processing (or display data (sidebar) display processing).

The present invention is not limited to the description of the embodiments above, but may be altered by a skilled person within the scope of the claims. An embodiment based on a proper combination of technical means disclosed in different embodiments is encompassed in the technical scope of the present invention.

[Supplementary 1]

For example, the information display device of the present invention may be arranged such that the relevant information storage section includes a writable storage area in which information is rewritably stored; the relevant information is registration information which is rewritably stored in the writable storage area in a nonvolatile manner; and the registration information is registered in accordance with a user's operation and specifies how the information display device operates.

Further, the relevant information storage section may include a read-only storage area in which information is stored in a read-only manner; and the relevant information is fixed information which is stored in the read-only storage area in a read only manner.

It is preferable that the information display device further includes a cache for temporarily storing the relevant information which is read out from the relevant information storage section by the relevant information transmitting section; the relevant information transmitting section reading out the relevant information from the cache and transmitting the relevant information to the information providing device when the control script specifies same relevant information as the relevant information which is read out from the relevant information storage section and is stored in the cache.

It is preferable that the information display device further includes: a server authentication section for performing authentication as to the information providing device which transmitted the control script for requesting the relevant information; if the server authentication section judges that the information providing device is a reliable communication partner, the relevant information transmitting section transmitting, to the authenticated information providing device, the relevant information specified by the control script.

It is possible that the server authentication section refers to a list of domain names of reliable information providing devices, the list being stored in the information display device in advance or being acquired from an external device guaranteed by a third party organization; and the server authentication section performs the authentication as to the information providing device which transmitted the control script, the server authentication section performs the authentication by comparing the domain names included in the list and a domain name of the information providing device.

It is preferable that the relevant information storage section stores the relevant information in such a manner that the relevant information is individually associated with information indicating whether or not the relevant information is secret information which should be protected so as not to be transmitted to an unreliable communication partner; and the server authentication section perform the authentication as to the information providing device which transmitted the control script, when relevant information specified by the control script is the secret information.

The information providing device of the present invention may be arranged such that the relevant information specification section specifies postal code information registered in the information display device, as the relevant information to be acquired, when the display data request message is a message for requesting display data for displaying information concerning a abiding place of a user of the information display device.

[Supplementary 2]

Various devices having different use, shape and function is used as an information display device. This necessitates devising a new method for displaying acquired information so that the information is most appropriately displayed on any information display device.

For example, the technique disclosed in the Patent Document 2 is a technique for solving problems caused by diversity of specifications of client-side devices. The Patent Document 2 discloses a display processing device which takes into consideration a display specification of a display device in generating GUI screen data and outputs the GUI screen data to the display device.

### PROBLEMS TO BE SOLVED BY THE INVENTION

However, the arrangement of the Patent Document 2 causes an increase in a load on a client (information display device) for displaying information.

If the technique disclosed in the Patent Document 2 is used for a server-client type information providing system, an amount of data transmitted between a server and a client becomes enormous. This causes an increase in a communication load. Further, the client must store the enormous amount of data. Furthermore, the client must execute processing of selecting contents. This causes an increase in a processing load of the client.

The present invention was attained in view of the above problems. Another object of the present invention is to realize an information providing device, an information display device, an information providing system, a control method, a control program and a storage medium, each of which makes it possible to provide information appropriate for a client while reducing a load on the client.

### MEANS TO SOLVE THE PROBLEMS

In order to attain the object, an information providing device of the present invention includes (i) a relevant information acquisition section for acquiring relevant information concerning an information display device, the relevant information being stored in the information display device, the relevant information being acquired in response to a request message for requesting display data for displaying information on the information display device, the request message being transmitted from the information display device, (ii) a template selecting section for selecting a template of display data corresponding to the relevant information acquired by the relevant information acquisition section, the template being selected with reference to corresponding information in which the relevant information is associated with the template of the display data prepared specially for the relevant information, and (iii) a display data generation section for generating the requested display data to be provided to the information display device, with use of the template of the display data selected by the template selecting section.

According to the above arrangement, display data can be customized specially for an information display device with use of the relevant information before the display data is provided to the information display device. This makes it possible to provide information appropriate for a client (information display device) without applying a load on the client.

It is preferable that the template of the display data specifies at least one of a display position and a display size of information displayed on a display screen of the information display device.

Alternately, the template of the display data may specify a display color of the displayed information.

It is preferable that the relevant information includes model information for specifying a model of the information display device, and the template selecting section selects, with reference to the corresponding information, a template of display data appropriate for a model specified by the model information acquired by the relevant information acquisition section.

It is preferable that the relevant information includes language setting information for specifying a language that is set in the information display device, and the template selecting section selects, with reference to the corresponding information, a template of display data that is described in a language specified by the language setting information acquired by the relevant information acquisition section.

Another arrangement is possible in which the display data generation section generates display data including (i) an information object for showing information requested by the information display device, and (ii) a control script for specifying how the information display device operates so as to display the information object in a predetermined position of a display screen. In a case in which the information display device is displaying a video picture based on a video signal acquired from the outside by the information display device, the control script instructs the information display device to operate so as to display the information object in a manner such that the information object is superimposed on the video picture. Alternately, when the information display device is displaying another object so that the another object is superimposed on the video picture, the control script may instruct the information display device to display the information object in a manner such that the information object does not overlap with the another object.

According to the above arrangement, the information providing device can provide the information display device with display data including a control script which instructs the information display device to display, in a predetermined position of a display screen, an information object for showing information that is requested by the information display device in a manner such that the information object is superimposed on a video picture (television broadcast screen) being displayed.

In a case in which the information display device displays information in accordance with the display data, the information display device can display the requested information in a predetermined position of a display screen in a manner such that the information is superimposed on a video picture that is being displayed.

This allows the information display device to display information on its display screen in such a manner that the displayed information does not hinder viewing an image that is being displayed on the information display device.

Further, it is preferable to avoid unnecessary superimposing processing and keep the superimposing processing to a minimum. It is unavoidable to superimpose the information object on an image such as a television broadcast screen. However, the information object can be displayed so as not to overlap with an OSD image (e.g. channel call, menu screen) that is being displayed. This makes it possible to avoid unnecessary superimposing processing in the information display device. This allows a reduction in a load of the information display device. Therefore, it is very effective.

In order to attain the object, an information display device of the present invention includes (i) a relevant information storage section for storing relevant information concerning the information display device, (ii) a request processing section for transmitting, to an information providing device, the relevant information stored in the relevant information storage section when the request processing section requests the information providing device for providing information to provide display data for displaying information, and (iii) a display data processing section for displaying the information on a display section in accordance with the display data that is generated by the information providing device on the basis of the relevant information in response to the request.

According to the above arrangement, the information display device transmits the relevant information to the information providing device when the information display device request the display data. This allows the information providing device to use the relevant information in providing, to the information display device, display data customized for the information display device. As a result, it is possible to provide information appropriate for a client (information display device) without applying a load on the client.

The relevant information storage section may include a storage area in which information is stored in a read-only manner. The relevant information may be fixed information that is stored in the storage area in a read-only manner.

Further, the fixed information may include the model information for specifying a model of the information display device.

Further, the relevant information storage section may include a storage area in which information is rewritably stored, and may include a relevant information setting section for storing, deleting or editing the relevant information in the relevant information storage section in accordance with a predetermined event.

The relevant information may be registration information that is stored in the relevant information storage section in a nonvolatile manner, or may be temporary information that is stored in the relevant information storage section in a volatile manner.

It is preferable that the information display device includes a display data storage section for storing display data received from the information providing device, and a data management section for judging whether or not the display data for displaying information specified by a user is stored in the display data storage section. If the data management section judges that the display data is stored in the display data storage section, the display data processing section does not request the display data, but the data management section reads out the display data from the display data storage section and displays the information specified by the user.

It is preferable that the display data includes a control script which instructs the information display device to store the display data in the display data storage section for a predetermined time period, and the data management section stores or deletes the display data in the display data storage section in accordance with the control script.

In order to attain the object, an information providing system of the present invention includes the information providing device and the information display device.

The information providing device generates display data customized based on the relevant information of the information display device and provides the display data to the information display device. The information display device displays information in accordance with the display data which the information providing device generated for the information display device.

This allows the information display device to appropriately display information in a way suitable for the information display device.

Therefore, it is possible to provide information appropriate for a client (information display device) without applying a load on the client.

In order to attain the object, a method for controlling an information providing device of the present invention, includes the steps of: (i) acquiring relevant information of an information display device, the relevant information being stored in the information display device, the relevant information being acquired in response to a request message for requesting display data for displaying information on the information display device, the request message being transmitted from the information display device, (ii) selecting a template of display data corresponding to the relevant information with reference to corresponding information in which the relevant information is associated with the template of the display data prepared specially for the relevant information, and (iii) generating the requested display data to be provided to the information display device with use of the selected template of the display data.

In order to attain the object, a method for controlling an information display device of the present invention is a method for controlling an information display device for displaying information, the method includes the steps of: (i) transmitting, to an information providing device for providing information, relevant information stored in a relevant information storage section for storing the relevant information concerning the information display device when the information display device requests the information providing device to provide display data for displaying information, and (ii) displaying information on a display section in accordance with the display data generated by the information providing device in response to the request on the basis of the relevant information.

### EFFECTS OF THE INVENTION

The above arrangement and method produce the effect that information appropriate for a client (information display device) can be provided without applying a load on the client. The information providing device of the present invention customizes information to be provided specially for each information display device for displaying information. Therefore, the information providing device of the present invention can be suitably applied to an information providing system in which an information display device selects, according to a state of the information display device, information from a plurality of information provided by a service provider, and displays the information.

Each of the information providing device and the information display device of the present invention may be realized by a computer by causing the computer to operate as the above sections which are function blocks of the information providing device and the information display device. In this case, (i) a control program of the information providing device realized by a computer, (ii) a control program of the information display device realized by a computer, and (iii) a computer-readable storage medium storing at least one of the control programs are included in a scope of the present invention.

Finally, each of the blocks of the digital television 1 (or the sidebar providing server 2), especially, the relevant information setting section 31 of the control section 10, the display data request processing section 32, the display data execution processing section 33, the browser processing section 34, the data management section 35, the server authentication section 37, and the error processing section 38 (alternatively, the request message analysis section 70 of the control section 60, the pattern data selecting section 62, the display data generation section 63, the service image acquisition section 64, the relevant information acquisition section 65, and the control script generation section 80) may be realized by way of hardware or software as executed by a CPU as follows.

That is, the digital television 1 (or the sidebar providing server 2) includes a CPU (central processing unit) and memory devices (memory media). The CPU (central processing unit) executes instructions in control programs realizing the functions. The memory devices include a ROM (read only memory) which contains programs, a RAM (random access memory) to which the programs are loaded, and a memory containing the programs and various data. The objective of the present invention can also be achieved by mounting to the digital television 1 (or the sidebar providing server 2) a computer-readable storage medium containing control program code (executable program, intermediate code program, or source program) for the digital television 1 (or the sidebar providing server 2), which is software realizing the aforementioned functions, in order for the computer (or CPU, MPU) to retrieve and execute the program code contained in the storage medium.

The storage medium may be, for example, a tape, such as a magnetic tape or a cassette tape; a disk including a magnetic disk, such as a floppy (Registered Trademark) disk or a hard disk, or an optical disk, such as CD-ROM/MO/MD/DVD/CD-R; a card, such as an IC card (memory card) or an optical card; or a semiconductor memory, such as a mask ROM/EPROM/EEPROM/flash ROM.

The digital television 1 (or the sidebar providing server 2) may be arranged to be connectable to a communications network so that the program code may be delivered over the communications network. The communications network is not limited in any particular manner, and may be, for example, the Internet, an intranet, extranet, LAN, ISDN, VAN, CATV communications network, virtual dedicated network (virtual private network), telephone line network, mobile communications network, or satellite communications network. The transfer medium which makes up the communications network is not limited in any particular manner, and may be, for example, wired line, such as IEEE 1394, USB, electric power line, cable TV line, telephone line, or ADSL line; or wireless, such as infrared radiation (IrDA, remote control), Bluetooth®, 802.11 wireless, HDR, mobile telephone network, satellite line, or terrestrial digital network. The present invention encompasses a carrier wave or data signal transmission in which the program code is embodied electronically.

### INDUSTRIAL APPLICABILITY

According to the information display device and the information providing device of the present invention, when information is customized specially for each information display device independently, the relevant information necessary for the customization by the information providing device can be efficiently transmitted/received between the information display device and the information providing device. Therefore, the present invention can be suitably applied to an information providing system which provides information in a manner such that the information is customized according to an information display device.

1. An information display device for (i) processing display data for displaying information, the display data being provided by an information providing device and (ii) displaying the information, comprising:
a relevant information storage section for storing relevant information concerning the information display device;
request processing means for transmitting a display data request message to the information providing device, the display data request message requesting the information providing device to provide the display data; and
relevant information transmitting means for transmitting, to the information providing device, relevant information specified by a control script among the relevant information stored in the relevant information storage section, the relevant information being transmitted in accordance with the control script for requesting the relevant information, the control script being transmitted from the information providing device in response to the display data request message.

2. The information display device according to claim 1, wherein:
the relevant information storage section includes a writable storage area in which information is rewritably stored;
the relevant information is registration information which is rewritably stored in the writable storage area in a nonvolatile manner; and
the registration information is registered in accordance with a user's operation and specifies how the information display device operates.

3. The information display device according to claim 1, wherein:
the relevant information storage section includes a read-only storage area in which information is stored in a read-only manner; and
the relevant information is fixed information which is stored in the read-only storage area in a read only manner.

4. The information display device according to claim 1, further comprising:
a cache for temporarily storing the relevant information which is read out from the relevant information storage section by the relevant information transmitting means;
the relevant information transmitting means reading out the relevant information from the cache and transmitting the relevant information to the information providing device when the control script specifies same relevant information as the relevant information which is read out from the relevant information storage section and is stored in the cache.

5. The information display device according to claim 1, further comprising:
server authentication means for performing authentication as to the information providing device which transmitted the control script for requesting the relevant information;
if the server authentication means judges that the information providing device is a reliable communication partner, the relevant information transmitting means transmitting, to the authenticated information providing device, the relevant information specified by the control script.

6. The information display device according to claim 5, wherein:
the server authentication means refers to a list of domain names of reliable information providing devices, the list being stored in the information display device in advance or being acquired from an external device guaranteed by a third party organization; and
the server authentication means performs the authentication as to the information providing device which transmitted the control script, the server authentication means performs the authentication by comparing the domain names included in the list and a domain name of the information providing device.

7. The information display device according to claim 5, wherein:
the relevant information storage section stores the relevant information in such a manner that the relevant information is individually associated with information indicating whether or not the relevant information is secret information which should be protected so as not to be transmitted to an unreliable communication partner; and
the server authentication means performs the authentication as to the information providing device which transmitted the control script, when relevant information specified by the control script is the secret information.

8. An information providing device comprising:
relevant information specification means for specifying relevant information concerning an information display device, the relevant information being necessary for generating the display data for displaying the information on the information display device, the display data being generated in response to the display data request message for requesting the display data, the display data request message being transmitted from the information display device;
control script generation means for generating the control script for requesting the information display device to provide the relevant information specified by the relevant information specification means; and
display data generation means for generating the display data to be provided to the information display device in a manner such that the display data is customized based on the relevant information transmitted from the information display device in response to an instruction of the control script to provide the relevant information.

9. The information providing device according to claim 8, wherein:
the relevant information specification means specifies postal code information registered in the information display device, as the relevant information to be acquired, when the display data request message is a message for requesting display data for displaying information concerning a abiding place of a user of the information display device.

10. (canceled)

11. A method for controlling an information display device which displays information by processing display data for displaying the information, which display data is provided by an information providing device, comprising the steps of:
transmitting a display data request message for requesting the information providing device to provide display data; and
transmitting, to the information providing device, relevant information specified by a control script among relevant information stored in relevant information storage section which stores relevant information concerning the information display device, the relevant information being transmitted in accordance with the control script for requesting the relevant information, the control script being transmitted from the information providing device in response to the display data request message.

12. A method for controlling an information providing device comprising the steps of:
specifying relevant information concerning an information display device, the relevant information being necessary for generating display data for displaying information on the information display device, the display data being generated in response to a display data request message for requesting the display data, the display data request message being transmitted from the information display device;
generating a control script for requesting the information display device to provide the specified relevant information; and
generating the display data to be provided to the information display device in a manner such that the display data is customized based on the relevant information transmitted from the infatuation display device in response to an instruction of the control script to provide the relevant information.

13. (canceled)

14. (canceled)

15. A computer-readable storage medium for storing a program for controlling an information display device which displays information by processing display data for displaying the information, which display data is provided by an information providing device, the program causing a computer to execute the steps of:
transmitting a display data request message for requesting the information providing device to provide display data; and
transmitting, to the information providing device, relevant information specified by a control script among relevant information stored in relevant information storage section which stores relevant information concerning the information display device, the relevant information being transmitted in accordance with the control script for requesting the relevant information, the control script being transmitted from the information providing device in response to the display data request message.

16. A computer-readable storage medium for storing a program for controlling an information providing device,
the program causing a computer to execute the steps of:
specifying relevant information concerning an information display device, the relevant information being necessary for generating display data for displaying information on the information display device, the display data being generated in response to a display data request message for requesting the display data, the display data request message being transmitted from the information display device;
generating a control script for requesting the information display device to provide the specified relevant information; and
generating the display data to be provided to the information display device in a manner such that the display data is customized based on the relevant information transmitted from the information display device in response to an instruction of the control script to provide the relevant information.
